(19) United States
(12) Patent Application Publication
(10) Pub. No.: US 2004/0247032 A1
(43) Pub. Date: Dec. 9, 2004

(54) Motion vector detection device and motion vector detection method

(76) Inventors: Yuichiro Aihara, Osaka (JP); Akihiko Otani, Osaka (JP); Akihiro Watabe, Nara (JP)

Correspondence Address: Jack Q Lever Jr, McDermott Will & Emery, 600 Thirteenth Street NW, Washington, DC, 20005-3096, US

(21) Appl. No.: 10/493,028

(22) PCT Filed: Jul. 25, 2003
(86) PCT No.: PCT/JP03/09501

(30) Foreign Application Priority Data
Jul. 29, 2002 (JP) 2002-220013

(51) Int. Cl. H04N 7/12

(52) U.S. Cl. 375/240.16; 375/240.24; 375/240.12

(57) ABSTRACT

An arithmetic operation means sequentially calculates estimation errors for respective candidate blocks based on pixel data of an odd-numbered or even-numbered field of a reference image frame and pixel data of an odd-numbered or even-numbered field of a current image block. A field comparator obtains the minimum estimation error from among the calculated estimation errors to detect a field motion vector. An AE storage stores a plurality of estimation errors calculated by the arithmetic operation means for one of predetermined combinations. An adder adds together the estimation errors calculated by the arithmetic operation means and a corresponding one of the plurality of estimation errors stored in the AE storage to calculate estimation errors on a frame-by-frame basis. A frame comparator obtains the minimum estimation error from among the estimation errors calculated on a frame-by-frame basis to detect a frame motion vector.

### TECHNICAL FIELD

The present invention relates to a motion vector detecting device and motion vector detecting method for obtaining a motion vector in a motion picture encoding device.

### BACKGROUND ART

There is a motion picture compressing method wherein information indicative of where in a current frame a certain portion of a picture in a previous frame was moved to (motion vector) is used to reduce the time redundancy.

The block matching method is well known as a technique for extracting a motion vector. In the block matching method, an image frame to be encoded (hereinafter, referred to as “current image frame”) is first divided into a plurality of blocks (current image blocks). On the other hand, a past or future frame (hereinafter, “reference image frame”) is divided into a plurality of blocks (reference image blocks), from which a reference image block having the highest correlation with the current image block is extracted. A relative displacement between the extracted reference image block and the current image block is defined as a motion vector.

In general, in order to extract a block having the highest correlation, subtraction is performed on all pixels between a current image block and a reference image block, the sum of absolute differences (or the sum of squared differences) is obtained, and a reference image block in which the obtained sum is minimum is detected, whereby a block having the highest correlation is extracted.

According to H.261 of the international standard ITU-T and ISO/IEC11172-2, only image encoding which is based on a sequential scanning method is dealt with, whereas the international standard ISO/IEC13818-2 also deals with image encoding which is based on an interlaced scanning method.

In interlaced scanning methods, one frame is formed according to the number of times of scanning which corresponds to the number of predetermined scanning lines, whereas in the sequential scanning methods, vertical scanning is sequentially performed on every signal line. For example, in a 2:1 interlaced scanning method, one frame is formed by two fields, a field of odd-numbered scanning lines and a field of even-numbered scanning lines, and one of the two fields is scanned before the other field is scanned. In this interlaced scanning method, the bandwidth of a signal is saved, and the number of times of scanning over the entire screen is increased without substantially decreasing the number of scanning lines, whereby flickering of an image is decreased.

Images of interlaced scanning methods have two types of structures, a frame structure where a frame is the unit of encoding and a field structure where a field is the unit of encoding. In the case of the frame structure, motion compensation and DCT encoding are performed on a frame-picture by frame-picture basis, each frame picture being formed by synthesizing two interlaced fields. In the case of the field structure, encoding is performed on a field-picture by field-picture basis, each field picture being formed by two interlaced fields. Further, estimation methods include a frame estimation method and a field estimation method.

Hereinafter, motion compensation in the frame structure is described.

Herein, it is assumed that a current image frame is formed by an odd-numbered field consisting of odd-numbered scanning lines and an even-numbered field consisting of even-numbered scanning lines, a reference image frame is formed by an odd-numbered field consisting of odd-numbered scanning lines and an even-numbered field consisting of even-numbered scanning lines, and the current image frame is estimated from the reference image frame.

Frame motion compensation estimation in the frame structure is performed such that a frame formed by synthesizing two interlaced fields is processed as the unit of estimation, and a displacement from a reference image frame to a current image frame is expressed as motion vector MV.

In field motion compensation estimation in the frame structure, motion compensation is performed on a field-by-field basis. Specifically, an odd-numbered field of a current image frame is estimated from an odd-numbered field or an even-numbered field of a reference image frame according to motion vector MV1, and an even-numbered field of the current image frame is estimated from an odd-numbered field or an even-numbered field of the reference image frame according to motion vector MV2. Then, the two fields, i.e., the odd-numbered field and the even-numbered field, are synthesized to estimate the current image frame from the reference image frame.

As described above, in the case of the frame structure, two motion vectors MV1 and MV2 are obtained by the field motion compensation estimation, and one motion vector MV is obtained by frame motion compensation estimation. That is, three motion vectors are obtained in total.

Frame motion vector MV of a certain frame is obtained from a result of addition of corresponding ones selected among the sums of absolute differences or the sums of squared differences (hereinafter, referred to as “AE(s)”) of a plurality of errors which are calculated as estimation errors while field motion vector MV1 of the odd-numbered field and field motion vector MV2 of the even-numbered field of the frame are obtained.

However, in a conventional motion vector detecting device, in order to obtain field motion vector MV1 of the odd-numbered field of a current image, field motion vector MV2 of the even-numbered field of the current image, and frame motion vector MV of the current image, it is necessary to separately provide two circuits, i.e., an arithmetic unit for calculating the AE corresponding to a current image block of the odd-numbered field of the current image and an arithmetic unit for calculating the AE corresponding to a current image block of the even-numbered field of the current image. The timing of these arithmetic units are synchronized to perform a parallel operation, and the AE of the odd-numbered field and the AE of the even-numbered field which are calculated by the respective arithmetic units are added together to obtain the AE corresponding to the frame. Furthermore, when each motion vector is obtained from the calculated AEs, it is necessary to separately provide three comparators, each of which compares the AE values at each candidate point and selects the minimum one among them, because the calculated AEs are output in parallel from the respective arithmetic units. As a result, the circuit size is large.

In general, in order to increase the possibility of selecting a block having a high correlation, it is necessary to extend the area to be searched in a reference image such that the number of candidate reference image blocks is increased. Accordingly, the hardware amount increases as the search area increases.

### DISCLOSURE OF INVENTION

In view of the above, an objective of the present invention is to provide a motion vector detecting device and motion vector detecting method wherein the reduction in circuit size is possible.

In order to achieve the above objective, the first motion vector detecting device of the present invention is a motion vector detecting device for detecting as a motion vector a candidate vector which minimizes an estimation error for a current image block in a current image frame with respect to a reference image frame, comprising: a reference image odd-numbered field storage for storing and outputting pixel data of an odd-numbered field which is a constituent of the reference image frame; a reference image even-numbered field storage for storing and outputting pixel data of an even-numbered field which is a constituent of the reference image frame; a current image storage for storing and outputting pixel data of the current image block; an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage; a field comparator for storing the estimation error calculated by the arithmetic operation means and comparing an estimation error newly calculated by the arithmetic operation means with the estimation error previously stored in the field comparator to retain the smaller estimation error and detect a field motion vector based on a minimum estimation error; an AE storage for storing a plurality of estimation errors calculated by the arithmetic operation means for one of combinations of an odd-numbered or even-numbered field of the reference image frame and an odd-numbered or even-numbered field of the current image block; an adder for adding together an estimation error calculated by the arithmetic operation means for a combination corresponding to the one combination and a corresponding one of the plurality of estimation errors stored in the AE storage to calculate an estimation error on a frame-by-frame basis; and a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

According to the first motion vector detecting device, the field motion vector is calculated in a time-division manner based on estimation errors sequentially calculated by the arithmetic operation means for respective candidate vectors of an original image block. Thus, it is not necessary to separately provide two circuits for calculation which are required in the conventional example. Accordingly, the hardware size required for calculation of the estimation errors is greatly reduced, and the hardware size of a field comparator required for obtaining the minimum estimation error from among the estimation errors calculated on a field-by-field basis is greatly reduced.

In the first motion vector detecting device, it is preferable that: the arithmetic operation means performs a first arithmetic operation of calculating estimation errors between the odd-numbered field of the reference image frame and the odd-numbered field of the current image block, a second arithmetic operation of calculating estimation errors between the even-numbered field of the reference image frame and the even-numbered field of the current image block, a third arithmetic operation of calculating estimation errors between the odd-numbered field of the reference image frame and the even-numbered field of the current image block, and a fourth arithmetic operation of calculating estimation errors between the even-numbered field of the reference image frame and the odd-numbered field of the current image block, the third and fourth arithmetic operations being performed before or after the first and second arithmetic operations; the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and the field comparator detects a second field motion vector based on the minimum one of the estimation errors calculated through the second arithmetic operation by the arithmetic operation means and the minimum one of the estimation errors calculated through the third arithmetic operation by the arithmetic operation means; the AE storage stores estimation errors calculated through any of the first to fourth arithmetic operations by the arithmetic operation means; the adder performs a first addition of adding together the estimation errors calculated through the first arithmetic operation and the estimation errors calculated through the second arithmetic operation, and a second addition of adding together the estimation errors calculated through the third arithmetic operation and the estimation errors calculated through the fourth arithmetic operation; and the frame comparator detects the frame motion vector based on a result of the first addition of the adder and a result of the second addition of the adder.

The second motion vector detecting device of the present invention is a motion vector detecting device for detecting as a motion vector a candidate vector which minimizes an estimation error for a current image block in a current image frame with respect to a reference image frame, comprising: a reference image odd-numbered field storage for storing and outputting pixel data of an odd-numbered field which is a constituent of the reference image frame; a reference image even-numbered field storage for storing and outputting pixel data of an even-numbered field which is a constituent of the reference image frame; a current image storage for storing and outputting pixel data of the current image block; and an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage, wherein the current image storage further stores a plurality of estimation errors calculated by the arithmetic operation means for one of combinations of an odd-numbered or even-numbered field of the reference image frame and an odd-numbered or even-numbered field of the current image block by overwriting the pixel data of the current image block, the motion vector detecting device further comprising: a field comparator for storing the estimation error calculated by the arithmetic operation means and comparing an estimation error newly calculated by the arithmetic operation means with the estimation error previously stored in the field comparator to retain the smaller estimation error and detect a field motion vector based on a minimum estimation error; an adder for adding together an estimation error calculated by the arithmetic operation means for a combination corresponding to the one combination and a corresponding one of the plurality of estimation errors stored in the current image storage to calculate an estimation error on a frame-by-frame basis; and a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

According to the second motion vector detecting device, the field motion vector is calculated in a time-division manner based on estimation errors sequentially calculated by the arithmetic operation means for respective candidate vectors of an original image block. Thus, it is not necessary to separately provide two circuits for calculation which are required in the conventional example. Accordingly, the hardware size required for calculation of the estimation errors is greatly reduced, and the hardware size of a field comparator required for obtaining the minimum estimation error from among the estimation errors calculated on a field-by-field basis is greatly reduced. Furthermore, the current image block storage is further used as means for temporarily storing estimation errors calculated on a field-by-field basis. Thus, it is not necessary to provide another storage, and accordingly, the hardware size is further reduced. Therefore, there is provided a motion vector detecting device which is readily realized in the form of a circuit.

In the second motion vector detecting device, it is preferable that: the arithmetic operation means performs a first arithmetic operation of calculating estimation errors between the odd-numbered field of the reference image frame and the odd-numbered field of the current image block, a second arithmetic operation of calculating estimation errors between the even-numbered field of the reference image frame and the even-numbered field of the current image block, a third arithmetic operation of calculating estimation errors between the odd-numbered field of the reference image frame and the even-numbered field of the current image block, and a fourth arithmetic operation of calculating estimation errors between the even-numbered field of the reference image frame and the odd-numbered field of the current image block, the third and fourth arithmetic operations being performed before or after the first and second arithmetic operations; the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and the field comparator detects a second field motion vector based on the minimum one of the estimation errors calculated through the second arithmetic operation by the arithmetic operation means and the minimum one of the estimation errors calculated through the third arithmetic operation by the arithmetic operation means; the current image storage stores estimation errors calculated through any of the first to fourth arithmetic operations by the arithmetic operation means by overwriting the pixel data of the current image block; the adder performs a first addition of adding together the estimation errors calculated through the first arithmetic operation and the estimation errors calculated through the second arithmetic operation, and a second addition of adding together the estimation errors calculated through the third arithmetic operation and the estimation errors calculated through the fourth arithmetic operation; and the frame comparator detects the frame motion vector based on a result of the first addition of the adder and a result of the second addition of the adder.

The third motion vector detecting device of the present invention is a motion vector detecting device for detecting as a motion vector a candidate vector which minimizes an estimation error for a current image block in a current image frame with respect to a reference image frame, comprising: a reference image odd-numbered field storage for storing and outputting pixel data of an odd-numbered field which is a constituent of the reference image frame; a reference image even-numbered field storage for storing and outputting pixel data of an even-numbered field which is a constituent of the reference image frame; a current image storage for storing and outputting pixel data of the current image block; an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage; a field comparator for storing the estimation error calculated by the arithmetic operation means and comparing an estimation error newly calculated by the arithmetic operation means with an estimation error previously stored in the field comparator to retain the smaller estimation error and detect a field motion vector based on a minimum estimation error; a register for storing estimation errors for one candidate vector which are calculated by the arithmetic operation means for one of combinations of an odd-numbered or even-numbered field of the reference image frame and an odd-numbered or even-numbered field of the current image block; an adder for adding together an estimation error calculated by the arithmetic operation means for a combination corresponding to the one combination and the estimation error stored in the register to calculate an estimation error on a frame-by-frame basis; and a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

According to the third motion vector detecting device, the field motion vector is calculated in a time-division manner based on estimation errors sequentially calculated by the arithmetic operation means for respective candidate vectors of an original image block. Thus, it is not necessary to separately provide two circuits for calculation which are required in the conventional example. Accordingly, the hardware size required for calculation of the estimation errors is greatly reduced, and the hardware size of a field comparator required for obtaining the minimum estimation error from among the estimation errors calculated on a field-by-field basis is greatly reduced. Furthermore, storage means which is necessary for calculation of the frame motion vector is realized only by a register for storing an estimation error for one candidate vector. Thus, the hardware size is reduced.

In the third motion vector detecting device, it is preferable that: the arithmetic operation means performs a first stage where a first arithmetic operation of calculating estimation errors between the odd-numbered field of the reference image frame and the odd-numbered field of the current image block and a second arithmetic operation of calculating estimation errors between the even-numbered field of the reference image frame and the even-numbered field of the current image block are alternately performed, and a second stage where a third arithmetic operation of calculating estimation errors between the odd-numbered field of the reference image frame and the even-numbered field of the current image block and a fourth arithmetic operation of calculating estimation errors between the even-numbered field of the reference image frame and the odd-numbered field of the current image block are alternately performed, the second stage being performed before or after the first stage; the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and the field comparator detects a second field motion vector based on the minimum one of the estimation errors calculated through the second arithmetic operation by the arithmetic operation means and the minimum one of the estimation errors calculated through the third arithmetic operation by the arithmetic operation means; the register stores estimation errors for the one candidate vector which are calculated through any of the first to fourth arithmetic operations by the arithmetic operation means; the adder performs a first addition of adding together the estimation errors calculated through the first arithmetic operation and the estimation errors calculated through the second arithmetic operation, and a second addition of adding together the estimation errors calculated through the third arithmetic operation and the estimation errors calculated through the fourth arithmetic operation; and the frame comparator detects the frame motion vector based on a result of the first addition of the adder and a result of the second addition of the adder.

The fourth motion vector detecting device of the present invention is a motion vector detecting device for detecting as a motion vector a candidate vector which minimizes an estimation error for a current image block in a current image frame with respect to a reference image frame, comprising: n reference image storages for storing and outputting pixel data of image segments obtained by thinning a field that is a constituent of the reference image frame at a cycle of n columns or n rows (where n is a natural number equal to or greater than 2); a current image storage for storing and outputting pixel data of the current image block; an arithmetic operation means for calculating estimation errors for respective candidate vectors of image segments of the current image block based on the pixel data of the image segments from the n reference image storages and pixel data of the image segments of the current image block, the image segments of the current image block being obtained by thinning the current image block from the current image storage at a cycle of n columns or n rows; registers for storing estimation errors for one candidate vector which are calculated by the arithmetic operation means for one of combinations of the image segments obtained by thinning the field which is a constituent of the reference image frame at a cycle of n columns or n rows and the image segments obtained by thinning the current image block at a cycle of n columns or n rows, the number of the registers being corresponding to the number of the combinations; an adder for adding together an estimation error calculated by the arithmetic operation means for a combination corresponding to the one combination and the estimation error for the one candidate vector which is stored in the register to calculate an estimation error on a field-by-field basis; and a frame comparator for storing the estimation error calculated by the adder on a field-by-field basis and comparing an estimation error newly calculated by the adder and the estimation error previously stored in the frame comparator to retain the smaller estimation error and detect a field motion vector based on the minimum estimation error.

According to the fourth motion vector detecting device, the field motion vector is calculated in a time-division manner based on estimation errors for respective candidate vectors of an image segment which are calculated using an image segment obtained by thinning a field that is a constituent of a reference image frame at a cycle of n columns or n rows and an image segment obtained by thinning a current image block at a cycle of n columns or n rows. Thus, it is not necessary to separately provide n circuits for calculation which are required in the conventional example. Accordingly, the hardware size required for calculation of the estimation errors is greatly reduced.

In the fourth motion vector detecting device, it is preferable that: the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame; the arithmetic operation means performs a first stage where a first arithmetic operation of calculating estimation errors between the odd-numbered columns of the field which is a constituent of the reference image frame and odd-numbered columns of the current image block and a second arithmetic operation of calculating estimation errors between the even-numbered columns of the field which is a constituent of the reference image frame and even-numbered columns of the current image block are alternately performed, and a second stage where a third arithmetic operation of calculating estimation errors between the odd-numbered columns of the field which is a constituent of the reference image frame and even-numbered columns of the current image block and a fourth arithmetic operation of calculating estimation errors between the even-numbered columns of the field which is a constituent of the reference image frame and odd-numbered columns of the current image block are alternately performed, the second stage being performed before or after the first stage; the registers, the number of which corresponds to the number of combinations, include one register for storing an estimation error for one candidate vector which is calculated through any of the first to fourth arithmetic operations by the arithmetic operation means; the adder performs a first addition of adding together the estimation errors calculated through the first arithmetic operation and the estimation errors calculated through the second arithmetic operation, and a second addition of adding together the estimation errors calculated through the third arithmetic operation and the estimation errors calculated through the fourth arithmetic operation; and the field comparator detects the field motion vector based on a result of the first addition of the adder and a result of the second addition of the adder.

The fifth motion vector detecting device of the present invention is a motion vector detecting device for detecting as a motion vector a candidate vector which minimizes an estimation error for a current image block in a current image frame with respect to a reference image frame, comprising: n reference image storages for storing and outputting pixel data of image segments obtained by thinning a field that is a constituent of the reference image frame at a cycle of n columns or n rows (where n is a natural number equal to or greater than 2); a current image storage for storing and outputting pixel data of image segments obtained by thinning a field which is a constituent of the current image block at a cycle of n columns or n rows; an arithmetic operation means for calculating estimation errors for respective candidate vectors of the image segments of the current image block based on the pixel data of the image segments from the n reference image storages and pixel data of the image segments from the current image storage; and a field comparator for comparing an estimation error calculated by the arithmetic operation means and a previously stored estimation error to retain the smaller estimation error and detect a field motion vector based on the minimum estimation error.

According to the fifth motion vector detecting device, estimation errors for respective candidate vectors of any one of an image segment obtained by thinning the current image block at a cycle of n columns or an image segment obtained by thinning the current image block at a cycle of n rows are sequentially calculated using an image segment obtained by thinning a field which is a constituent of a reference image frame at a cycle of n columns or n rows to calculate the field motion vector in a time-division manner. Thus, it is not necessary to separately provide n circuits for calculation which are required in the conventional example. Accordingly, the hardware size required for calculation of the estimation errors is greatly reduced. Thus, high arithmetic operation efficiency is retained even though the number of combinations for the arithmetic operation is greatly reduced as compared with the first to fourth motion vector detecting devices. Therefore, simplified motion vector detection is realized without changing the position accuracy of motion vectors. As a result, the process time required for detecting motion vectors can be reduced to about a half.

In the fifth motion vector detecting device, it is preferable that: the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame; the arithmetic operation means alternately performs a first arithmetic operation of calculating estimation errors between the odd-numbered columns of the field which is a constituent of the reference image frame and odd-numbered columns of the current image block and a second arithmetic operation of calculating estimation errors between the even-numbered columns of the field which is a constituent of the reference image frame and odd-numbered columns of the current image block; and the field comparator detects the field motion vector based on a result of the first arithmetic operation of the arithmetic operation means and a result of the second arithmetic operation of the arithmetic operation means.

In the fifth motion vector detecting device, it is preferable that: the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame; the arithmetic operation means alternately performs a first arithmetic operation of calculating estimation errors between the odd-numbered columns of the field which is a constituent of the reference image frame and odd-numbered columns of the current image block and a second arithmetic operation of calculating estimation errors between the even-numbered columns of the field which is a constituent of the reference image frame and even-numbered columns of the current image block; and the field comparator detects the field motion vector based on a result of the first arithmetic operation of the arithmetic operation means and a result of the second arithmetic operation of the arithmetic operation means.

The first motion vector detecting method of the present invention is a motion vector detecting method for detecting as a motion vector a candidate vector which minimizes an estimation error for a current image block in a current image frame with respect to a reference image frame, comprising the steps of: sequentially calculating estimation errors for respective candidate vectors of the current image block, for combinations of an odd-numbered or even-numbered field which is a constituent of the reference image frame and an odd-numbered or even-numbered field of the current image block, based on pixel data of the odd-numbered or even-numbered field of the reference image frame and pixel data of the odd-numbered or even-numbered field of the current image frame; calculating the minimum estimation error among the sequentially calculated estimation errors to calculate a field motion vector; and storing a plurality of estimation errors calculated for one of the combinations on a field-by-field basis and calculating a frame motion vector based on an estimation error calculated for a combination corresponding to the one combination and a corresponding one of the plurality of stored estimation errors.

According to the first motion vector detecting method, the field motion vector is calculated in a time-division manner based on estimation errors sequentially calculated for respective candidate vectors of an original image block. Thus, it is not necessary to separately provide two circuits for calculation which are required in the conventional example. Accordingly, the hardware size required for calculation of the estimation errors is greatly reduced, and the hardware size of a field comparator required for obtaining the minimum estimation error from among the estimation errors calculated on a field-by-field basis is greatly reduced.

In the first motion vector detecting method, it is preferable that the step of calculating the frame motion vector includes the step of storing the plurality of estimation errors which are calculated for one of the combinations by overwriting a region where the pixel data of the reference image frame or the pixel data of the current image block is stored.

With such a structure, a region for storing pixel data of a current image block or pixel data of a reference image frame is further used as means for temporarily storing estimation errors calculated on a field-by-field basis. Thus, it is not necessary to provide another storage, and accordingly, the hardware size is further reduced.

The second motion vector detecting method of the present invention is a motion vector detecting method for detecting as a motion vector a candidate vector which minimizes an estimation error for a current image block in a current image frame with respect to a reference image frame, comprising the steps of: sequentially calculating estimation errors for respective candidate vectors of the current image block, for combinations of an odd-numbered or even-numbered field which is a constituent of the reference image frame and an odd-numbered or even-numbered field of the current image block, based on pixel data of the odd-numbered or even-numbered field of the reference image frame and pixel data of the odd-numbered or even-numbered field of the current image frame; calculating the minimum estimation error among the sequentially calculated estimation errors to calculate a field motion vector; and storing an estimation error for one candidate vector which is calculated for one of the combinations and calculating a frame motion vector based on an estimation error calculated for a combination corresponding to the one combination and the stored estimation error for the one candidate vector.

According to the second motion vector detecting method, the field motion vector is calculated in a time-division manner based on estimation errors sequentially calculated for respective candidate vectors of an original image block. Thus, it is not necessary to separately provide two circuits for calculation which are required in the conventional example. Accordingly, the hardware size required for calculation of the estimation errors is greatly reduced, and the hardware size of a field comparator required for obtaining the minimum estimation error from among the estimation errors calculated on a field-by-field basis is greatly reduced. Furthermore, it is sufficient for calculation of a frame motion vector that only an estimation error for one candidate vector is stored. Thus, the hardware size can be reduced.

The third motion vector detecting method of the present invention is a motion vector detecting method for detecting as a motion vector a candidate vector which minimizes an estimation error for a current image block in a current image frame with respect to a reference image frame, comprising the steps of: sequentially calculating estimation errors for respective candidate vectors of image segments of the current image block, for combinations of pixel data of image segments of the reference image frame and pixel data of the image segments of the current image block, based on the pixel data of the image segments of the reference image frame and the pixel data of the image segments of the current image block, the image segments of the reference image frame being obtained by thinning a field which is a constituent of the reference image frame at a cycle of n columns or n rows, and the image segments of the current image block being obtained by thinning the current image block at a cycle of n columns or n rows (where n is a natural number equal to or greater than 2); and storing an estimation error for one candidate vector which is calculated for one of the combinations and calculating a field motion vector based on an estimation error calculated for a combination corresponding to the one combination and the stored estimation error for the one candidate vector.

According to the third motion vector detecting method, the field motion vector is calculated in a time-division manner based on estimation errors for respective candidate vectors of an image segment which are calculated using an image segment obtained by thinning a field that is a constituent of a reference image frame at a cycle of n columns or n rows and an image segment obtained by thinning a current image block at a cycle of n columns or n rows. Thus, it is not necessary to separately provide 2 circuits for calculation which are required in the conventional example. Accordingly, the hardware size required for calculation of the estimation errors is greatly reduced. Furthermore, the hardware size of the field comparator which is required for obtaining the minimum estimation error from among the estimation errors calculated on a field-by-field basis is greatly reduced. Therefore, simplified motion vector detection which is readily applied to a thinned version of an arithmetic operation is realized without changing the search area or the position accuracy of motion vectors.

The fourth motion vector detecting method of the present invention is a motion vector detecting method for detecting as a motion vector a candidate vector which minimizes an estimation error for a current image block in a current image frame with respect to a reference image frame, comprising the steps of: sequentially calculating estimation errors for respective candidate vectors of image segments of the current image block based on the pixel data of image segments of the reference image frame and the pixel data of any one of the image segments of the current image block, the image segments of the reference image frame being obtained by thinning a field which is a constituent of the reference image frame at a cycle of n columns or n rows, and the image segments of the current image block being obtained by thinning the current image block at a cycle of n columns or n rows (where n is a natural number equal to or greater than 2); and calculating a field motion vector based on the sequentially calculated estimation errors.

According to the fourth motion vector detecting method, estimation errors for respective candidate vectors of any one of an image segment obtained by thinning the current image block at a cycle of n columns or an image segment obtained by thinning the current image block at a cycle of n rows are sequentially calculated using an image segment obtained by thinning a field which is a constituent of a reference image frame at a cycle of n columns or n rows to calculate the field motion vector in a time-division manner. Thus, it is not necessary to separately provide 2 circuits for calculation which are required in the conventional example. Accordingly, the hardware size required for calculation of the estimation errors is greatly reduced. Furthermore, the hardware size of the field comparator which is required for obtaining the minimum estimation error from among the estimation errors calculated on a field-by-field basis is greatly reduced. Thus, high arithmetic operation efficiency is retained even though the number of combinations for the arithmetic operation is greatly reduced as compared with the first to third motion vector detecting methods. Therefore, simplified motion vector detection is realized without changing the position accuracy of motion vectors. As a result, the process time required for detecting motion vectors can be reduced to about a half.

### BRIEF DESCRIPTION OF DRAWINGS

FIG. 1 shows an example of the structure of a motion vector detecting device according to embodiment 1 of the present invention.

FIG. 2 shows an example of the internal structure of an arithmetic unit according to embodiment 1.

FIG. 3 shows an example of the structure of a processor element according to embodiment 1.

FIG. 4 illustrates the relationship between a current image frame block and a search area in a reference image frame.

FIG. 5 shows the relationship between a current image frame block and a reference image frame.

FIGS. 6(a) to 6(c) illustrate a method for dividing a candidate vector region according to embodiment 1.

FIG. 7 shows data of the components of embodiment 1 for respective times.

FIG. 8 illustrates a pipeline process achieved by the arithmetic unit according to embodiment 1.

FIG. 9 shows an example of the structure of a motion vector detecting device according to embodiment 2 of the present invention.

FIG. 10 shows an example of the internal structure of an arithmetic unit according to embodiment 2.

FIG. 11 shows an example of the structure of a processor element according to embodiment 2.

FIG. 12 shows an example of the structure of a motion vector detecting device according to embodiment 3 of the present invention.

FIG. 13 shows an example of the internal structure of an arithmetic unit according to embodiment 3.

FIGS. 14(a) to 14(c) illustrate a method for dividing a candidate vector region according to embodiment 3.

FIG. 15 shows data of the components of embodiment 3 for respective times.

FIG. 16A illustrates a pipeline process achieved by the arithmetic unit according to embodiment 3.

FIG. 16B illustrates a pipeline process achieved by the arithmetic unit according to embodiment 3.

FIG. 17 shows the relationship between a current image odd-numbered field and a reference image odd-numbered field according to embodiment 4.

FIG. 18 shows an example of the structure of a motion vector detecting device according to embodiment 4 of the present invention.

FIGS. 19(a) to 19(c) illustrate a method for dividing a candidate vector region according to embodiment 4.

FIG. 20 shows data of the components of embodiment 4 for respective times.

FIG. 21A illustrates a pipeline process achieved by an arithmetic unit according to embodiment 4.

FIG. 21B illustrates a pipeline process achieved by an arithmetic unit according to embodiment 4.

FIG. 22 shows data of the components of embodiment 4 for respective times.

FIG. 23 shows an example of the structure of a motion vector detecting device according to embodiment 5.

FIGS. 24(a) to 24(c) illustrate a method for dividing a candidate vector region according to embodiment 5.

FIG. 25 shows data of the components of embodiment 5 for respective times.

FIG. 26 illustrates a pipeline process achieved by an arithmetic unit according to embodiment 5.

### BEST MODE FOR CARRYING OUT THE INVENTION

Hereinafter, embodiments of the present invention will be described with reference to the drawings.

It should be noted that the same or equivalent parts are denoted by the same reference numerals throughout the drawings referred to in the following embodiments, and the descriptions thereof are not repeated.

(Embodiment 1)

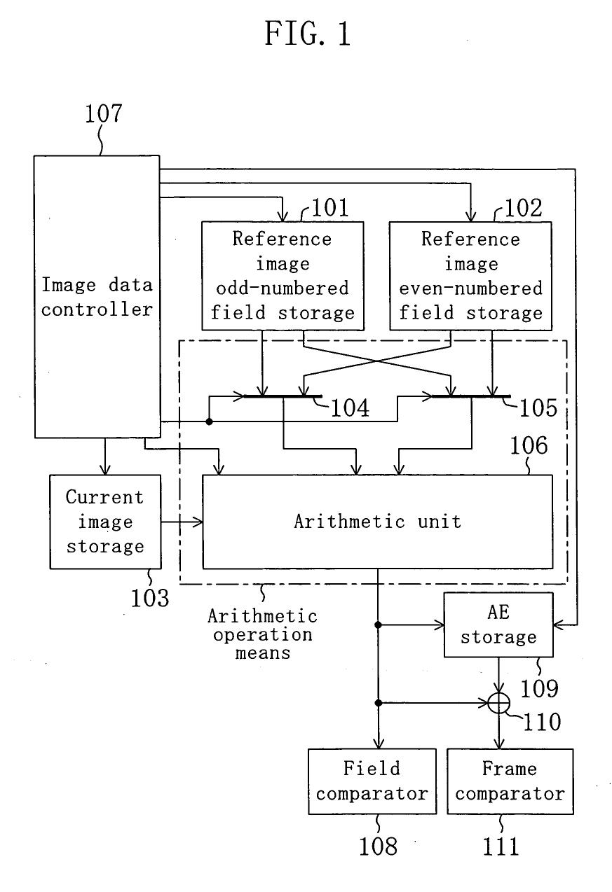

FIG. 1 shows an example of the structure of a motion vector detecting device 100 according to embodiment 1 of the present invention.

The motion vector detecting device 100 shown in FIG. 1 includes a reference image odd-numbered field storage 101, a reference image even-numbered field storage 102, a current image storage 103, reference image parity selection means 104 and 105 (included in arithmetic operation means), an arithmetic unit 106 (included in arithmetic operation means), an image data controller 107, a field comparator 108, an AE storage 109, an adder 110 and a frame comparator 111.

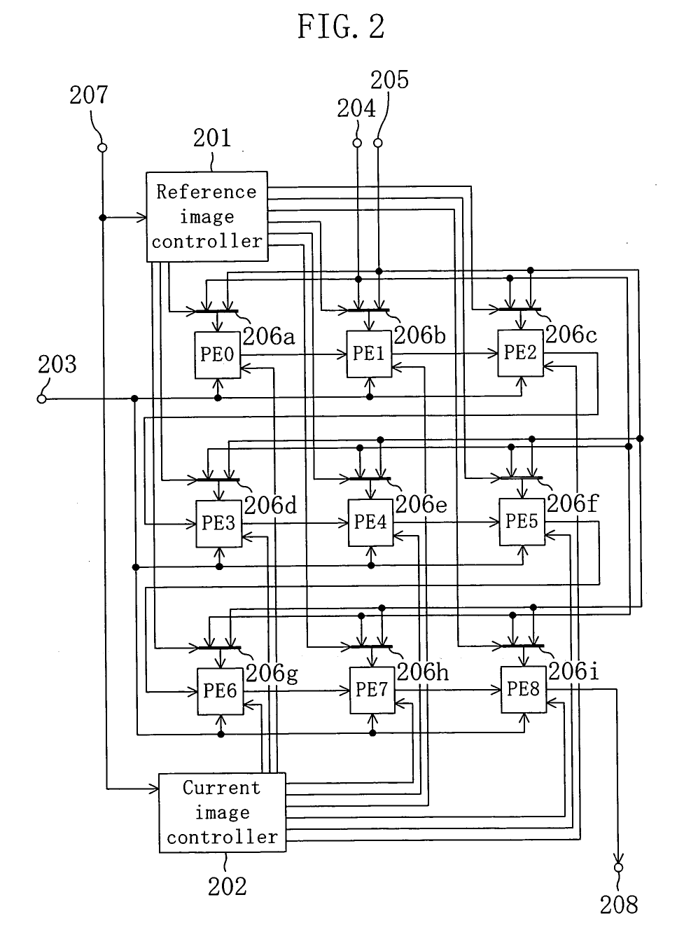

FIG. 2 shows an example of the internal structure of the arithmetic unit 106 of FIG. 1.

The arithmetic unit 106 shown in FIG. 2 includes processor elements PE0 to PE8, a reference image controller 201, a current image controller 202, a current image data input 203, reference image data inputs 204 and 205, reference image data selection means 206a to 206i, an activation signal input 207 and an AE output 208.

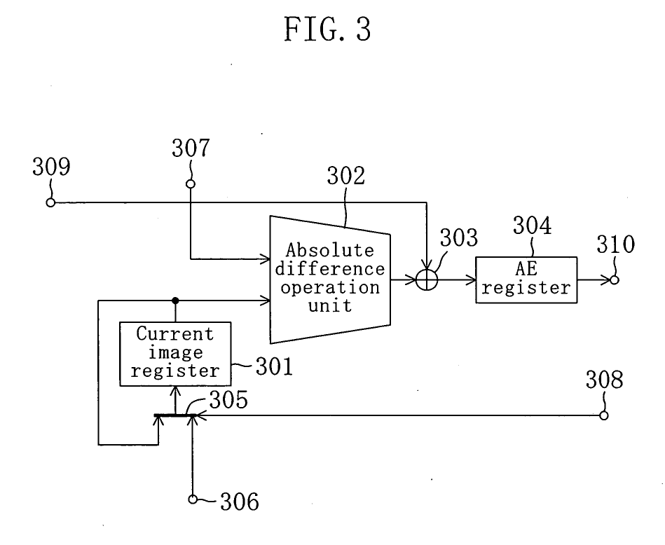

FIG. 3 shows an example of the internal structure of the processor elements PE0 to PE8 shown in FIG. 2.

An example of the processor elements PE0 to PE8 shown in FIG. 3 includes a current image register 301, an absolute difference operation unit 302, an adder 303, an AE register 304, a current image input selection means 305, a current image data input 306, a reference image data input 307, a current image control signal input 308, an accumulated absolute difference sum input 309 and an AE output 310.

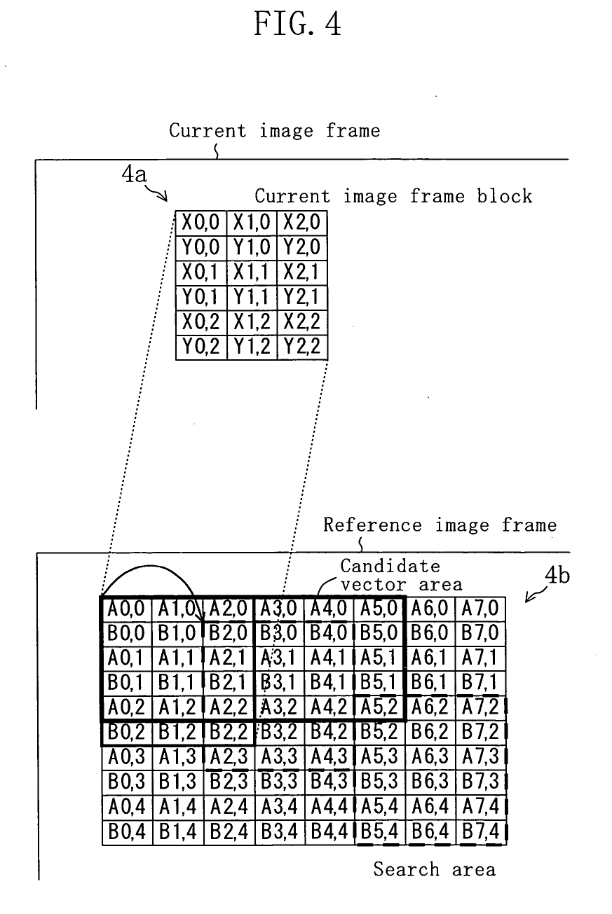

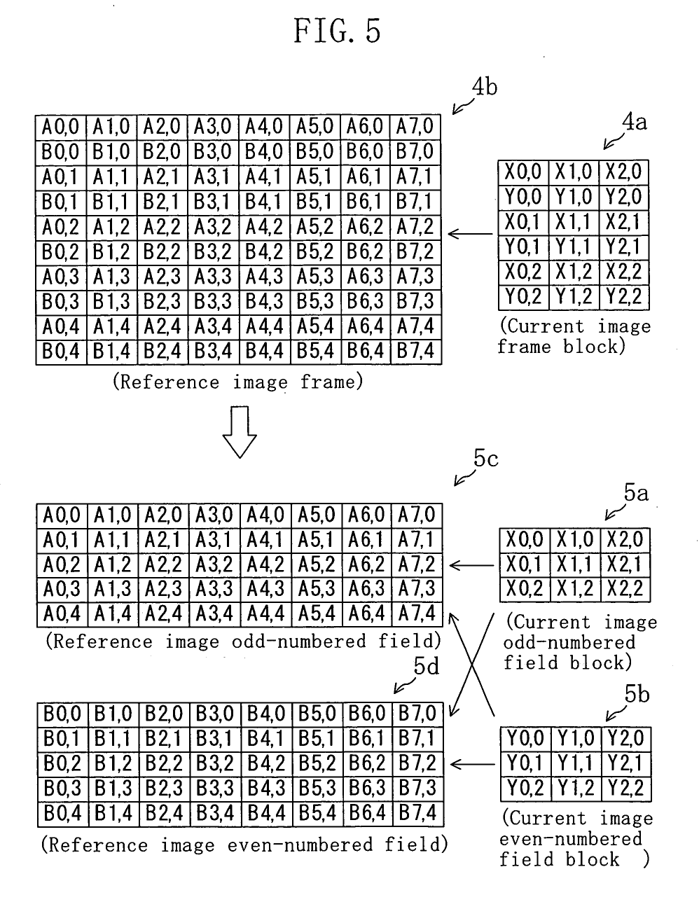

In the following descriptions, for example, as shown in FIG. 4, the size of a current image frame block 4a is 3×6 pixels, and the search area 4b in the reference image frame is 8×10 pixels. In FIG. 4, the area of candidate vectors is shown in the search area 4b. This diagram can be converted to a field-based format as shown in FIG. 5. That is, the current image frame block 4a of FIG. 4 can be expressed by a current image odd-numbered field block 5a and a current image even-numbered field block 5b. The reference image frame block 4b of FIG. 4 can be expressed by a reference image odd-numbered field block 5c and a reference image even-numbered field block 5d.

As shown in FIG. 1, in the motion vector detecting device 100 of embodiment 1, the reference image odd-numbered field storage 101 stores, as reference image data, pixel data of the odd-numbered field including the search area 4b in the reference image frame (hereinafter, referred to as “odd-numbered field pixel data”). The reference image even-numbered field storage 102 stores, as reference image data, pixel data of the even-numbered field including the search area 4b in the reference image frame (hereinafter, referred to as “even-numbered field pixel data”). The current image storage 103 stores pixel data of the current image block as current image data.

The reference image parity selection means 104 and 105, which are controlled by a parity control signal output from the image data controller 107, determine which of the odd-numbered field pixel data stored in the reference image odd-numbered field storage 101 and the even-numbered field pixel data stored in the reference image even-numbered field storage 102 is supplied to the arithmetic unit 106. That is, the image data controller 107 controls the reference image odd-numbered field storage 101 and the reference image even-numbered field storage 102 by the parity control signal. The image data controller 107 controls data output from the current image storage 103 by a control signal and generates an activation signal which is supplied to the reference image controller 201 and the current image controller 202 in the arithmetic unit 106 shown in FIG. 2. Further, the image data controller 107 controls the AE storage 109 by a control signal.

The arithmetic unit 106 sequentially calculates AEs for respective candidate vectors on a field-by-field basis using pipeline processing based on the reference image data and current image data input to the arithmetic unit 106.

As shown in FIG. 2, the arithmetic unit 106 includes the processor elements PE0 to PE8, the number of which is equal to the number of pixels of the current image block in one frame. The reference image controller 201 controls reference image data which is to be supplied to the processor elements PE0 to PE8. The current image controller 202 controls current image data which is to be supplied to the processor elements PE0 to PE8 shown in FIG. 3.

As shown in FIG. 3, the processor elements PE0 to PE8, which are constituents of the arithmetic unit 106, each store in the register 301 data of the current image block in one field and then receive the pixel data of the reference image every clock cycle. The absolute difference operation unit 302 calculates the sum of absolute differences (SAD) for one pixel. The adder 303 adds the output of a processor element at the previous stage to the SAD from the absolute difference operation unit 302. A result of the addition is temporarily stored in the AE register 304 and then output therefrom one cycle later to a processor element at the subsequent stage. That is, the processor elements PE0 to PE8 are arranged in a so-called cascade connection configuration.

From among the AEs sequentially output from the arithmetic unit 106, an AE having the minimum value is selected by the field comparator 108. The AEs sequentially output from the arithmetic unit 106 are temporarily stored in the AE storage 109. The temporarily stored AEs are each output from the AE storage 109 at a timing when an AE of a different field of a corresponding candidate vector is output later from the arithmetic unit 106, and then added at the adder 110. In this way, the AEs are sequentially calculated for respective candidate vectors on a frame-by-frame basis, and the minimum AE is selected at the frame comparator 111 from among the AEs calculated on a frame by frame basis.

The AE storage 109 has the capacity for storing the AE for all of the candidate vectors of one field. Accordingly, a structure where the arithmetic unit 106 calculates a series of AEs only on a field-by-field basis is possible.

Herein, an arithmetic operation for one of the combinations of the parities of the current image field block and the reference image field is performed through two steps.

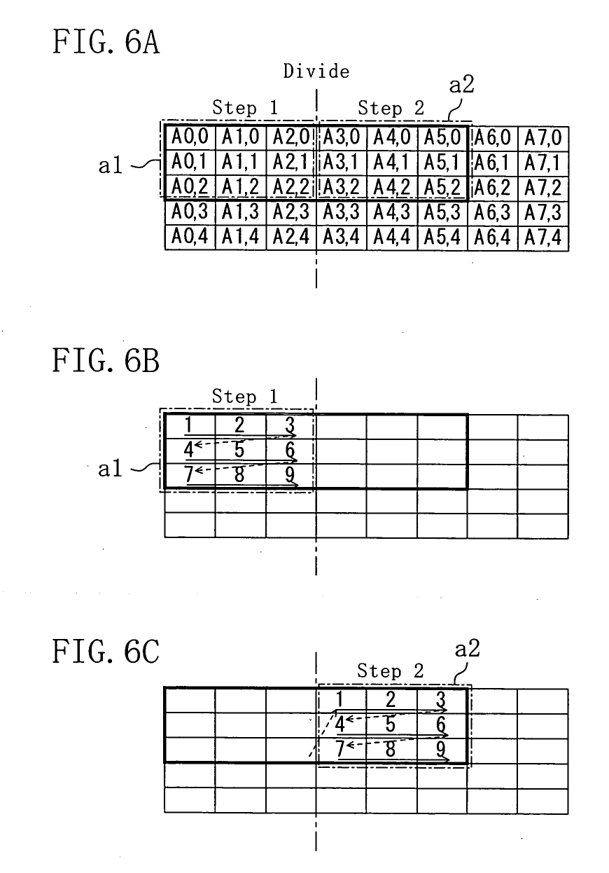

FIG. 6 illustrates the order of search among candidate blocks within a search area in an odd-numbered field, for example. In FIGS. 6(b) and 6(c), a pixel at the upper left corner of each candidate block is a representative point of the candidate block. The order of search among the candidate blocks is indicated by an arrow which represents the movement of the representative point. In the description provided below, candidate vector (0, 0) with the upper left pixel as a representative point is represented by coordinate (A0, 0). The coordinates of candidate vectors are represented with the assumption that the horizontal rightward direction and vertical downward direction are positive directions.

In the first place, as shown in FIG. 6(a), a candidate vector area is divided into a plurality of regions each of which has a width corresponding to the number of horizontally-arranged pixels of a current image frame block (i.e., 3 pixels).

First, in the left area a1, the process starts with the upper left candidate block and horizontally proceeds such that 3 candidate blocks are sequentially processed. Then, the process moves downward by one row, and horizontally-arranged 3 candidate blocks are processed from the left end. Such a process is repeated three times such that 9 candidate blocks are processed as shown in FIG. 6(b) (Step 1).

Then, in the right area a2, the process starts with a candidate block at the upper left position, which has a representative point (A3, 0), and 9 candidate blocks are processed according to the order shown in FIG. 6(c) (Step 2).

The search is performed in the same order on all the combinations of odd-numbered fields and even-numbered fields of the current image and reference image.

Hereinafter, the operation of the motion vector detecting device 100 according to embodiment 1 of the present invention is described.

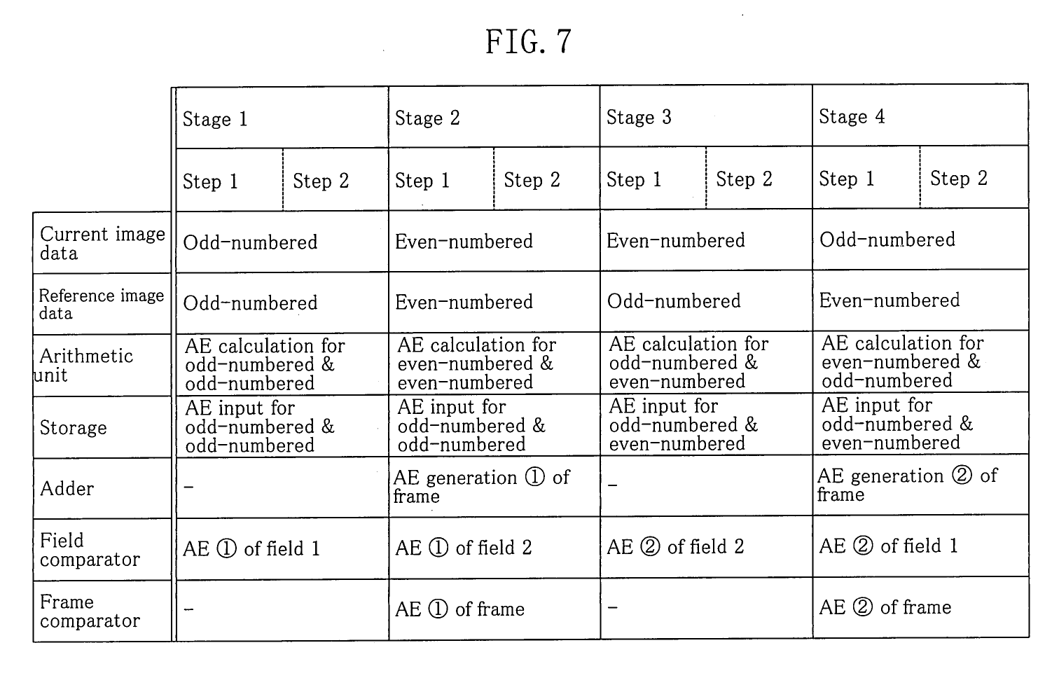

FIG. 7 shows the parity of data of the components included in the motion vector detecting device 100 of embodiment 1 at respective times.

The operation of the motion vector detecting device 100 is described through 4 stages, as shown in FIG. 7, for the combinations of the parities of the fields of the current image block and the fields of the reference image.

<Stage 1>

At Stage 1, an arithmetic operation for a combination of a current image odd-numbered field block 5a and a reference image odd-numbered field Sc (which corresponds to the first arithmetic operation) is performed.

In the first place, the odd-numbered field pixel data of the current image odd-numbered field block 5a, which is stored in the current image storage 103, is supplied to the arithmetic unit 106.

As shown in FIG. 2, the current image data input from the current image data input 203 is input to all of the processor elements PE0 to PE8. The current image input selection means 305 included in each of the processor elements PE0 to PE8 controlled by the current image controller 202 selects whether the register 301 stores the input current image data or retains the value currently stored therein.

Pixel data [X0, 0], [X1, 0], [X2, 0], [X0, 1], [X1, 1], . . . [X1, 2], and [X2, 2] of the current image odd-numbered field block 5a shown at the right middle part of FIG. 5 are stored as current image data in the registers 301 of the processor elements PE0, PE1, PE2, . . . PE8, respectively, and retained there till the calculation of AEs at all of the search points at Stage 1.

The reference image parity selection means 104 and 105 shown in FIG. 1 operate such that two pieces of odd-numbered field pixel data of the reference image odd-numbered field 5c from the reference image odd-numbered field storage 101 are supplied to the reference image data inputs 204 and 205 in the arithmetic unit 106 according to the parity control signal from the image data controller 107.

As shown in FIG. 2, the reference image data selection means 206a to 206i controlled by the reference image controller 201 each select one of the two pieces of reference image data supplied from the reference image inputs 204 and 205 for use in the processor elements PE0 to PE8.

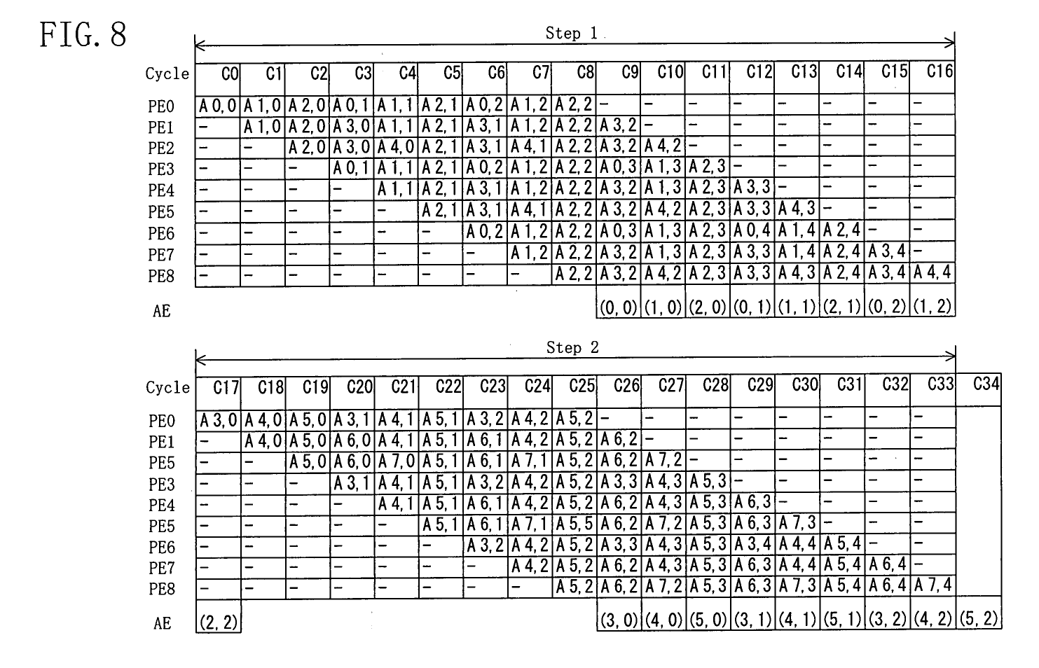

Next, the operation of obtaining a series of AEs is specifically described with reference to FIG. 8.

FIG. 8 illustrates pipeline processing achieved in the arithmetic unit 106, wherein reference image data required by the processor elements PE0 to PE8 in respective cycles are shown.

In the first cycle (C0), pixel data of (A0, 0) is output from the reference image odd-numbered field storage 101 and input to the arithmetic unit 106 through the reference image data input 204. In the arithmetic unit 106, the reference image data selection means 206a connected to the processor element PE0 selects the reference image data input 204. In the other processor elements, i.e., the processor elements PE1 to PE8, the arithmetic operation results are invalidated, and therefore, any of the reference image inputs 204 and 205 may be selected. In the second cycle (C1), pixel data of (A1, 0) is input to the processor elements PE0 and PE1. In the third cycle (C2), pixel data of (A2, 0) is input to the processor elements PE0, PE1 and PE2.

In the fourth cycle (C3), two pieces of pixel data of (A0, 1) and (A3, 0) are output from the reference image odd-numbered field storage 101 and input to the arithmetic unit 106 through the reference image inputs 204 and 205, respectively. In the arithmetic unit 106, the reference image data selection means 206a and 206d, which are connected to the processor elements PE0 and PE3, respectively, each select the reference image input 204. The reference image data selection means 206b and 206c, which are connected to the processor elements PE1 and PE2, respectively, each select the reference image input 205.

As described above, two input lines are provided to the arithmetic unit 106 so as to cover a case where two pieces of data is concurrently required. Further, the reference image data is supplied according to the order of search as shown in FIG. 6, whereby the pipeline processing is not interrupted, and the number of pieces of data the arithmetic unit 106 concurrently requires is suppressed to 2 at the maximum.

At any time after that, the pixel data necessary to the processor elements PE0 to PE8 are sequentially supplied as shown in FIG. 7, whereby the sums of absolute differences for candidate blocks are accumulated. As a result, in the tenth cycle (C9) to the eighteenth cycle (C17), the arithmetic unit 106 sequentially outputs the AEs of candidate blocks corresponding to candidate vectors (0, 0) to (2, 2) at Step 1. In the meantime, two pieces of data input to the processor elements PE0 to PE8 are adaptively selected, whereby a continuous arithmetic operation is possible.

After the arithmetic operation of Step 1 has been completed, the pixel data necessary for the processor elements PE0 to PE8 are supplied to perform an arithmetic operation of Step 2. With this operation, calculation of the AEs at all of the search points for the combinations of the odd numbered field block of the current image and the odd-numbered field of the reference image is completed.

The sequentially-calculated AEs between the current image odd-numbered field block 5a and the reference image odd-numbered field 5c are also input to the field comparator 108, from which the minimum AE is selected for obtaining field motion vector MV1. Further, the AE storage 109 stores all of the AEs according to a control signal from the image data controller 107.

<Stage 2 (Corresponding to Second Stage)>

At Stage 2, as shown in FIG. 7, an arithmetic operation for a combination of the current image even-numbered field block 5b and the reference image even-numbered field 5d (which corresponds to the second arithmetic operation) is performed.

In the first place, the even-numbered field pixel data of the current image even-numbered field block 5b, which is stored in the current image storage 103, is supplied to the arithmetic unit 106.

Pixel data [Y0, 0], [Y1, 0], [Y2, 0], [Y0, 1], [Y1, 1], . . . [Y1, 2], and [Y2, 2] of the current image even-numbered field block 5b shown at the right lower part of FIG. 5 are stored as current image data in the registers 301 of the processor elements PE0, PE1, PE2, . . . PE8, respectively, and retained there till the calculation of AEs at all of the search points at Stage 2 is completed.

Then, the arithmetic unit 106 is supplied with the reference image data of the reference image even-numbered field 5d to perform the arithmetic operation. Herein, the reference image parity selection means 104 and 105 shown in FIG. 1 operate such that the even-numbered field pixel data of the reference image even-numbered field 5d, which has been output from the reference image even-numbered field storage 102, is supplied to the arithmetic unit 106. As a result, the even-numbered field pixel data of the reference image even-numbered field 5d is input to the arithmetic unit 106, in which the AEs for all of the search points are obtained in the same manner as described in Stage 1.

The sequentially-calculated AEs for the combinations of the current image even-numbered field block 5b and the reference image even-numbered field 5d are input to the field comparator 108, from which the minimum AE is selected for obtaining field motion vector MV2. Further, all of the AEs are input to the adder 110.

The AEs for the combinations of the current image odd-numbered field block 5a and the reference image odd-numbered field 5c, which have been stored in the AE storage 109 at Stage 1, are output from the AE storage 109 and input to the adder 110 in synchronization with the AEs sequentially output from the arithmetic unit 106 based on a control signal from the image data controller 107.

In the adder 110, corresponding two AEs input to the adder 110 are added together to sequentially calculate AEs on a frame-by-frame basis. The resultant AEs are the AEs of candidate vectors corresponding to even-numbered vertical lines in a frame.

The frame comparator 111 is supplied with the AEs calculated by the adder 110 and selects and retains the minimum AE for obtaining frame motion vector MV.

<Stage 3>

At Stage 3, as shown in FIG. 7, the reference image data supplied is switched to that of the reference image odd-numbered field 5c as used at Stage 1 while retaining the current image data of the current image even-numbered field block 5b in the arithmetic unit 106. Under such a condition, a series of arithmetic operations (corresponding to the third arithmetic operation) are performed to calculate the AEs between the current image even-numbered field block 5b and the reference image odd-numbered field 5c. The calculated AEs are input to the field comparator 108 as in Stage 1, and field motion vector MV2 is obtained in consideration of the stored result of Stage 2. On the other hand, the calculated AEs are stored in the AE storage 109.

<Stage 4>

At Stage 4, as shown in FIG. 7, the pixel data of the current image odd-numbered field block 5a is again supplied to the arithmetic unit 106, and the pixel data of the reference image even-numbered field 5d is again used as the reference image data to perform the arithmetic operation for the combination of the current image odd-numbered field block 5a and the pixel data of the reference image even-numbered field 5d (which corresponds to the fourth arithmetic operation). The AEs calculated in the same manner are input to the field comparator 108 as in Stage 2, and field motion vector MV1 is obtained in consideration of the result of Stage 1. On the other hand, the calculated AEs are added at the adder 110 to the corresponding AEs calculated between the current image even-numbered field block 5b and the reference image odd-numbered field 5c which are the result of the arithmetic operation at Stage 3 and have been read from the AE storage 109 at a synchronous timing, whereby AEs are obtained on a frame-by-frame basis. These AEs are the AEs of the candidate vectors corresponding to odd-numbered vertical lines in a frame.

These AEs obtained on a frame-by-frame basis are input to the frame comparator 111 to obtain frame motion vector MV in consideration of the stored result of Stage 2.

As described above, according to embodiment 1, all of the combinations of the odd-numbered field and even-numbered field are processed in a time-division manner, whereby frame motion vector MV, field motion vector MV1 and field motion vector MV2, i.e., 3 vectors in total, are obtained. Thus, it is possible to provide a motion vector detecting device with a reduced circuit size. In addition, the arithmetic operations are performed with high efficiency because pipeline processing is employed.

It should be noted that in embodiment 1 the current image data is supplied to the arithmetic unit 106 before the start of arithmetic operations, but the present invention is not limited thereto. For example, in the case of supplying the pixel data of the current image odd-numbered field block 5a, the pixel data is supplied to the arithmetic unit 106 in the order of [X0, 0], [X1, 0], [X2, 0], [X0, 1], [X1, 1], . . . [X1, 2], [X2, 2]. In the case of supplying the pixel data of the current image even-numbered field block 5b, the pixel data is supplied to the arithmetic unit 106 in the order of [Y0, 0], [Y1, 0], [Y2, 0], [Y0, 1], [Y1, 1], . . . [Y1, 2], [Y2, 2]. The timing for supplying the current image data and reference image data to the arithmetic unit 106 is adjusted such that supply of the pixel data of the current image and the arithmetic operation are concurrently performed, whereby the process time is shortened.

(Embodiment 2)

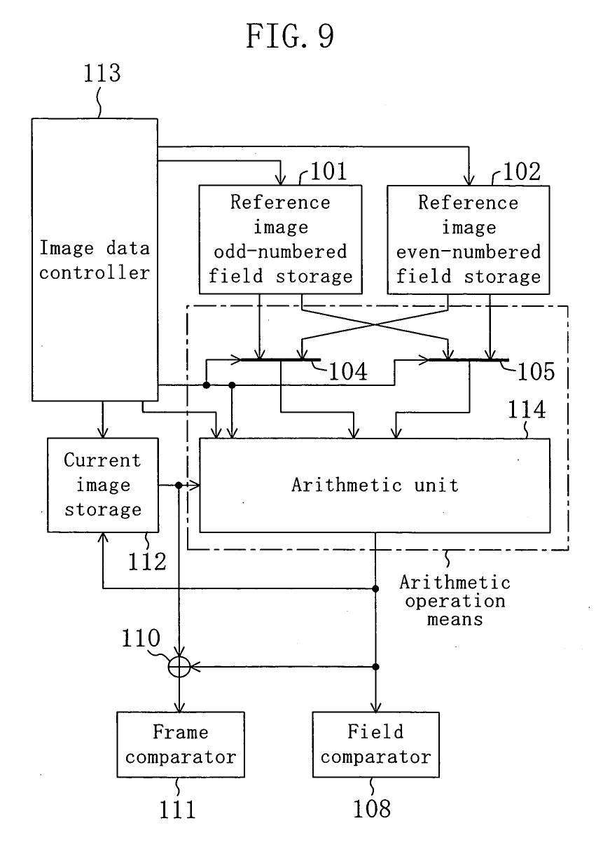

FIG. 9 shows an example of the structure of a motion vector detecting device 200 according to embodiment 2 of the present invention.

The following description is given with an example of the current image frame block and the reference image frame shown in FIGS. 4 and 5 as in embodiment 1.

The motion vector detecting device 200 shown in FIG. 9 includes a current image storage 112, an image data controller 113 and an arithmetic unit 114 (corresponding to arithmetic operation means). The other components are the same as those of embodiment 1.

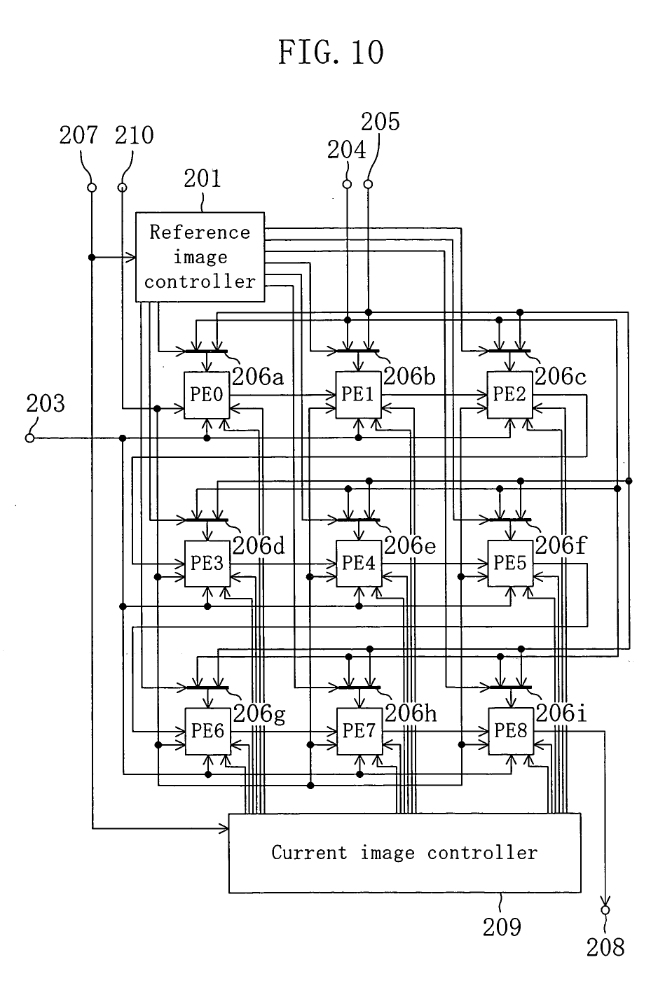

FIG. 10 shows an example of the internal structure of the arithmetic unit 114 of FIG. 9.

The arithmetic unit 114 shown in FIG. 10 includes processor elements PE0 to PE8, the number of which is equal to the number of pixels of a candidate block in one field, a current image controller 209, and a current image parity control signal input 210. The other components of the arithmetic unit 114 are the same as those of the arithmetic unit 106 of embodiment 1.

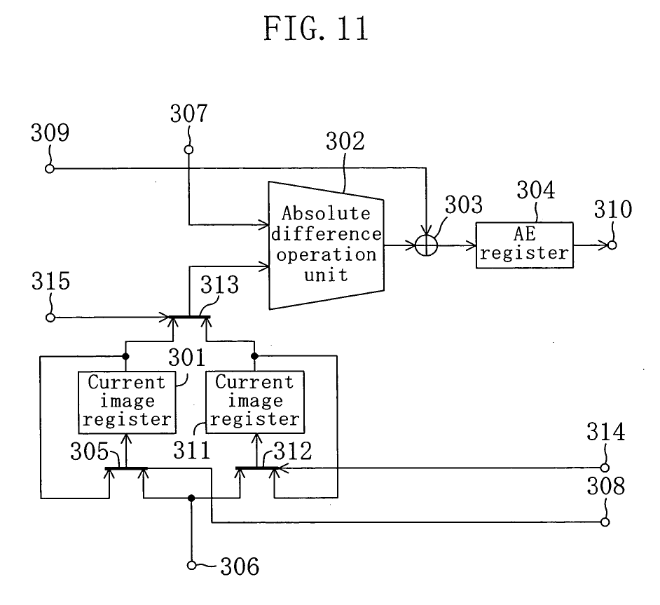

FIG. 11 shows an example of the internal structure of the processor elements PE0 to PE8 shown in FIG. 10.

The processor element PE shown in FIG. 11 includes a second current image register 311, a second current image input selection means 312, a current image parity selector 313, a second current image control signal input 314 and a current image parity control input 315. The other components of the processor element PE are the same as those of the processor element of embodiment 1.

The current image storage 112 shown in FIG. 9 stores the pixel data of the current image frame block as in embodiment 1. The parity control signal from the image data controller 113 is also input to the arithmetic unit 114.

The arithmetic unit 114 sequentially calculates AEs for respective candidate vectors on a field-by-field basis using pipeline processing based on the input reference image data and the retained current image data.

An example of the processor elements PE0 to PE8 shown in FIG. 11 is structured such that the image data of both one field and the other field of the current image data are stored in the two registers, i.e., the image registers 301 and 311, and which of these image registers is used can be selected at the time of arithmetic operations. The operation of the processor elements PE0 to PE8 is controlled by a control signal from the current image controller 209 when data is stored but is controlled by a control signal from the image data controller 113 when the arithmetic operation of data is performed. The processor elements PE0 to PE8 are arranged in a cascade connection configuration. The absolute difference operation unit 302 calculates the sum of absolute differences (SAD) between the current image data selected by the current image parity selector 313 and the pixel data of the reference image which is received every clock cycle. Then, at the adder 303, the SAD calculated by the absolute difference operation unit 302 is added to the SAD input from a processor element PE of the previous stage through the accumulated absolute difference sum input 309. The result of the addition is output to a processor element PE of the subsequent stage one cycle after.

From among the AEs sequentially output from the arithmetic unit 114, the field comparator 108 selects the minimum AE. On the other hand, the AEs sequentially output from the arithmetic unit 114 are temporarily stored in the current image storage 112 in such a manner that the AEs are written over the stored current image data.

The current image storage 112 receives a control signal from the image data controller 113 to output each of the stored AEs at a timing when an AE in a different field of a corresponding candidate vector is output from the arithmetic unit 114. The AEs output from the current image storage 112 are added to an AE from the arithmetic unit 114 at the adder 110. In this way, AEs for respective candidate vectors are sequentially calculated on a frame-by-frame basis, and from among the calculated AEs, the minimum AE is selected by the frame comparator 111.

Herein, the current image storage 112 has a capacity for storing at least a bigger one of all the pixel data of the current image block and the AEs for all the candidate blocks in one field.

As described above, the current image storage 112 which is originally provided for storing the current image data is further used for temporarily storing the AEs that have been calculated on a frame-by-frame basis for obtaining frame motion vector MV. Thus, it is not necessary to provide a new storage device. Accordingly, the hardware size is reduced, and the circuit is simplified. Further, the reference image odd-numbered field storage 101 or the reference image even-numbered field storage 102 is further used as means for temporarily storing the AEs calculated on a field-by-field basis for obtaining frame motion vector MV, whereby the hardware size is reduced.

Hereinafter, the operation of embodiment 2 of the present invention is described.

The order of search among candidate blocks is the same as that shown in FIG. 6 of embodiment 1.

The pixel data of the current image block, which is stored in the current image storage 112, is supplied to the arithmetic unit 114.

As shown in FIG. 10, the current image data input from the current image data input 203 is input to all of the processor elements PE0 to PE8, the current image input selection means 305 and 312 of each of the processor elements PE0 to PE8 controlled by the current image controller 209 select whether or not the pixel data of the input current image is stored in the registers 301 or 311.

Pixel data [X0, 0], [X1, 0], [X2, 0], [X0, 1], [X1, 1], . . . [X1, 2], and [X2, 2] of the current image odd-numbered field block 5a shown at the right middle part of FIG. 5 are stored as current image data in the registers 301 of the processor elements PE0, PE1, PE2, . . . PE8, respectively. Pixel data [Y0, 0], [Y1, 0], [Y2, 0], [Y0, 1], [Y1, 1], [Y1, 2], and [Y2, 2] of the current image even-numbered field block 5b are stored as current image data in the registers 311 of the processor elements PE0, PE1, PE2, . . . PE8, respectively. These pixel data are retained till the calculation of AEs is entirely completed. Thus, the current image storage 112 does not need to keep on retaining the data stored in the arithmetic unit 114.

Next, the operation of supplying the reference image data to the arithmetic unit 114 to obtain a series of AEs is described. The flow of the operation is the same as that described in embodiment 1 with reference to FIG. 7. The description below is divided for respective stages.

<Stage 1>

In the first place, the image data controller 113 controls the current image parity selector 313 by a current image parity control signal such that all of the processor elements PE0 to PE8 in the arithmetic unit 114 use data of the current image odd-numbered field block 5a which is stored in the current image register 301 as the current image data. Then, as in the case of FIG. 8 of embodiment 1, the odd-numbered field pixel data for the reference image odd-numbered field 5c is supplied to the arithmetic unit 114 to perform an arithmetic operation of Stage 1 (which corresponds to the first arithmetic operation).

The sequentially-calculated AEs between the current image odd-numbered field block 5a and the reference image odd-numbered field 5c are input to the field comparator 108. The field comparator 108 selects and retains the minimum AE for obtaining field motion vector MV1. On the other hand, according to a control signal from the image data controller 113, all of the sequentially-calculated AEs are temporarily stored in the current image storage 112 in such a manner that the AEs are written over an area storing the current image data that have already been supplied to the arithmetic unit 114.

<Stage 2>

Then, the image data controller 113 controls the current image parity selector 313 by the current image parity control signal, whereby all of the processor elements PE0 to PE8 in the arithmetic unit 114 use as the current image data the data of the current image even-numbered field block 5b which is stored in the current image registers 311. The even-numbered field pixel data for the reference image even-numbered field 5d is supplied to the arithmetic unit 114 as in the case of FIG. 8 of embodiment 1, whereby the arithmetic operation of Stage 2 (which corresponds to the second arithmetic operation) is performed.

The sequentially-calculated AEs for the combination of the current image even-numbered field block 5b and the reference image even-numbered field 5d are input to the field comparator 108. The field comparator 108 selects and retains the minimum AE for obtaining field motion vector MV2. On the other hand, all of the sequentially-calculated AEs are input to the adder 110. Receiving a control signal from the image data controller 113, the current image storage 112 outputs the AEs between the current image odd-numbered field block 5a and the reference image odd-numbered field 5c, which have been stored at Stage 1, are output in synchronization with the AEs sequentially output from the arithmetic unit 114. The AEs output from the current image storage 112 are input to the adder 110.

The adder 110 adds together the input two AEs, thereby sequentially calculating AEs on a frame-by-frame basis. These AEs are the AEs of the candidate vectors corresponding to the even-numbered vertical lines of a frame.

Then, the frame comparator 111 is supplied with the AEs calculated by the adder 110 and selects and retains the minimum AE for obtaining frame motion vector MV.

<Stage 3>

The reference image data to be supplied is again switched to the pixel data of the reference image odd-numbered field 5c as in Stage 1 while the current image even-numbered field block 5b is retained as the current image data subsequently used to perform an arithmetic operation of Stage 3 (which corresponds to the third arithmetic operation). The calculated AEs are input to the field comparator 108 as in embodiment 1. The field comparator 108 obtains field motion vector MV2 in consideration of the retained result of Stage 2. On the other hand, the calculated AEs are stored in the current image storage 112.

<Stage 4>

At Stage 4, the current image data used is switched to the pixel data of the current image odd-numbered field block 5a as in Stage 1, and the pixel data of the reference image even-numbered field 5d is again used as the reference image data to perform an arithmetic operation (which correspond to the fourth arithmetic operation). The calculated AEs are input to the field comparator 108 as in Stage 2. The field comparator 108 obtains field motion vector MV1 in consideration of the result of Stage 1. On the other hand, the adder 110 adds the calculated AEs to the AEs which have been calculated at Stage 3 and read from the current image storage 112 with a synchronous timing to calculate AEs on a frame-by-frame basis. These AEs are the AEs of the candidate vectors corresponding to odd-numbered vertical lines in a frame. The AEs calculated on a frame-by-frame basis are input to the frame comparator 111. In the frame comparator 111, frame motion vector MV is obtained in consideration of the retained result of Stage 2.

As described above, according to embodiment 2, all of the combinations of the odd-numbered fields and even-numbered fields of the current image and reference image are processed in a time-division manner, whereby frame motion vector MV, field motion vector MV1 and field motion vector MV2, i.e., 3 vectors in total, are obtained. The current image storage 112 which is originally provided for storing the current image data is further used for temporarily storing the AEs that have been calculated on a field-by-field basis for obtaining frame motion vector MV. Thus, it is not necessary to provide a new storage device. Accordingly, the hardware size is reduced, and the circuit is simplified.

In the above-described example of embodiment 2, the current image storage 112 is further used as means for temporarily storing the AEs that have been calculated on a field-by-field basis for obtaining frame motion vector MV. However, the hardware size may also be reduced by using the reference image odd-numbered field storage 101 or the reference image even-numbered field storage 102 for temporarily storing the AEs.

In embodiment 2, the order of supplying the current image data to the arithmetic unit 114 is not particularly specified, but the operation of embodiment 2 may be carried out as described below. For example, the arithmetic operation is performed while supplying current image data to the registers in the processor elements PE, e.g., in the order of [X0, 0], [X1, 0], [X2, 0], [X0, 1], [X1, 1], . . . , [X1, 2], and [X2, 2] at Stage 1 in the case of the current image odd-numbered field block 5a, in synchronization with the timing of supplying reference image data to the arithmetic unit 114. The arithmetic operation results are stored in the current image storage 112 such that the pixel data of the current image even-numbered field block 5b are not overwritten. In the case of the current image even-numbered field block 5b, the arithmetic operation is performed while supplying data to the arithmetic unit 114 in the order of [Y0, 0], [Y1, 0], [Y2, 0], [Y0, 1], [Y1, 1], [Y1, 2], and [Y2, 2] at Stage 2. In this way, supply of the pixel data of the current image and the arithmetic operation are concurrently performed, whereby the total process time is reduced.

In embodiments 1 and 2, the combinations of the reference image fields and the current image fields are considered in the order of (odd-numbered field and odd-numbered field), (even-numbered field and even-numbered field), (odd-numbered field and even-numbered field) and (even-numbered field and odd-numbered field), but it is not necessary to follow this order. It is only required that the stages of the combinations of fields having the same parity occur consecutively while the stages of the combinations of fields having different parities occur consecutively.

(Embodiment 3)

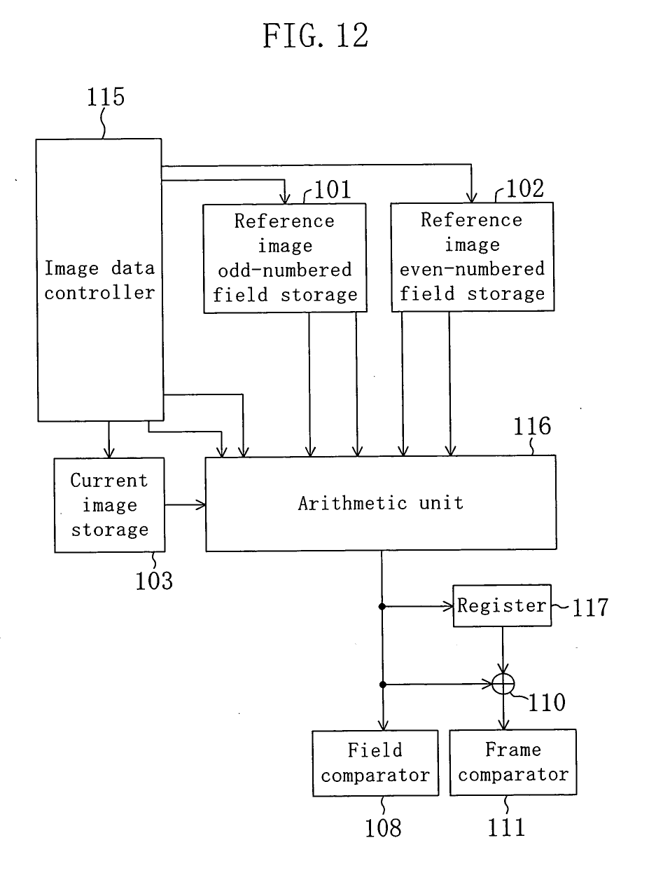

FIG. 12 shows an example of the structure of a motion vector detecting device 300 according to embodiment 3 of the present invention.

The following description is given with an example of the current image frame block and the reference image frame shown in FIGS. 4 and 5 as in embodiment 1.

The motion vector detecting device 300 shown in FIG. 12 includes an image data controller 115, an arithmetic unit 116 (corresponding to arithmetic operation means), and a register 117 capable of storing the AE of one search point (the estimation error for one candidate block). The other components are the same as those of the motion vector detecting device 100 of embodiment 1.

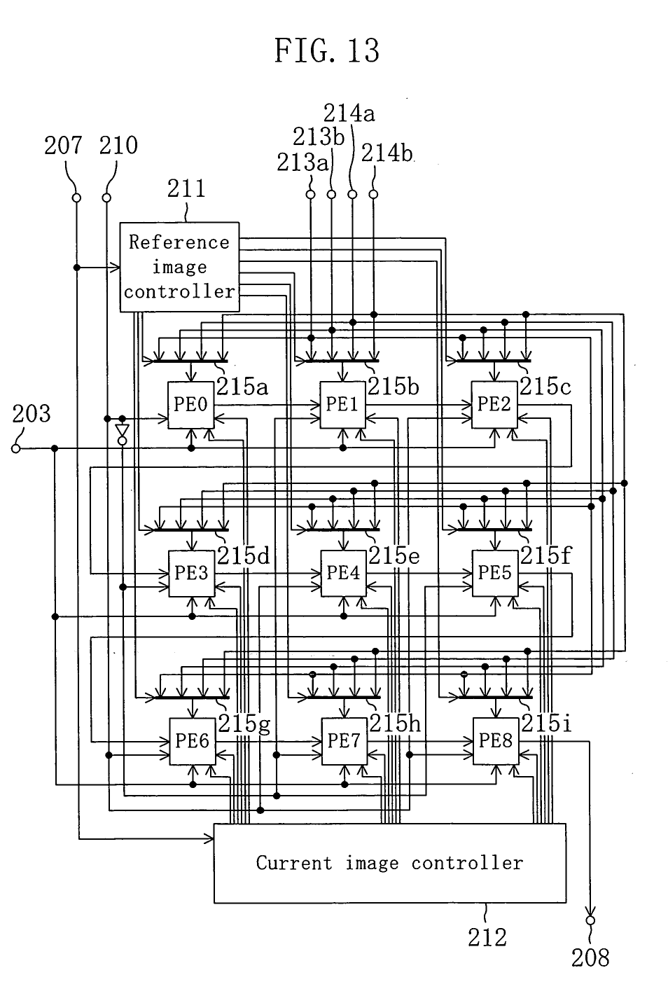

FIG. 13 shows an example of the internal structure of the arithmetic unit 116 of FIG. 12. The arithmetic unit 116 has processor elements PE, the number of which is equal to the number of pixels of a candidate block in one field. The processor elements PE0 to PE8 are the same as those shown in FIG. 11 of embodiment 2. The arithmetic unit 116 shown in FIG. 13 includes a reference image controller 211, a current image controller 212, reference image odd-numbered field data inputs 213a and 213b, reference image even-numbered field data inputs 214a and 214b, and reference image data selection means 215a to 215i. The other components of the arithmetic unit 116 are the same as those of the processor element of embodiment 2.

In embodiment 3, the reference image odd-numbered field storage 101 and the reference image even-numbered field storage 102 supply two pieces of pixel data of the reference image odd-numbered field and two pieces of pixel data of the reference image even-numbered field, respectively, to the arithmetic unit 116 as they are.

The arithmetic unit 116 sequentially calculates AEs for respective candidate vectors on a field-by-field basis using pipeline processing based on the input reference image data and current image data stored therein.

In the arithmetic unit 116, the processor elements PE having odd numbers and the processor elements PE having even numbers operate to alternately perform arithmetic operations for different parities according to control signals from the image data controller 115 and the reference image controller 211. With such an operation, the arithmetic unit 116 alternately outputs the AEs for different combinations of parities every cycle because the processor elements PE0 to PE8 are arranged in a cascade connection configuration.

The AEs output from the arithmetic unit 116 are input to the field comparator 108. The field comparator 108 selects an AE having the minimum value. On the other hand, the AEs output from the arithmetic unit 116 are temporarily stored in the register 117.

The AEs temporarily stored in the register 117 are output from the register 117 in the next clock cycle and input to the adder 110. The adder 110 adds the AEs to the AEs for corresponding combinations of different parities which are output from the arithmetic unit 116 to calculate AEs on a frame-by-frame basis. The results of the addition are input to the frame comparator 111. The frame comparator 111 determines the minimum AE among the AEs calculated on a frame-by-frame basis.

The processor elements PE0 to PE8 are used differently as described above for respective clock cycles such that the AEs for fields of different parities are alternately output from the arithmetic unit 116. Thus, frame motion vector MV can be obtained only with one added register without using an unnecessary storage device. Accordingly, the hardware size is reduced while the above-described functions are readily realized in the form of a circuit.

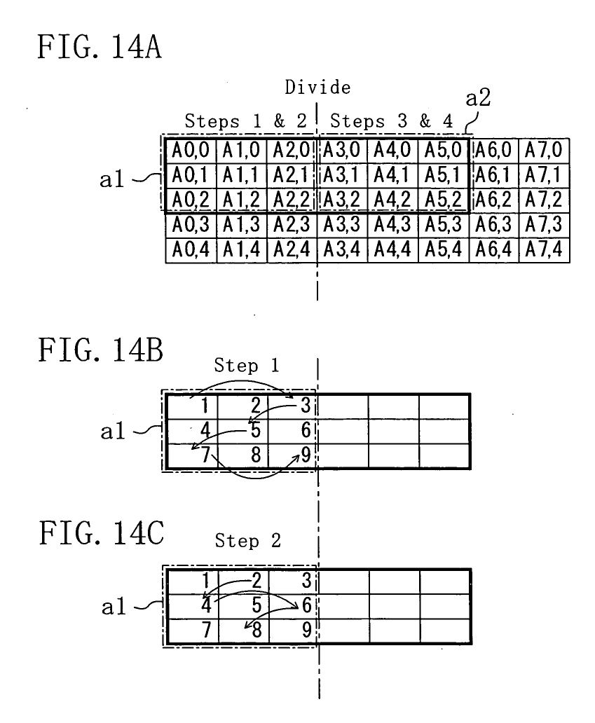

The order of search among candidate blocks is now described with reference to FIG. 14.

FIG. 14 illustrates the order of search among candidate blocks within a search area in the case of the reference image odd-numbered field 5c shown in FIG. 5. In the following description, candidate vector (0, 0) with the upper left pixel as a representative point is represented by coordinate (A0, 0). The coordinates of candidate vectors are represented with the assumption that the horizontal rightward direction and vertical downward direction are positive directions.

As shown in FIG. 14(a), a candidate vector area is divided into a plurality of regions each of which has a width corresponding to the number of horizontally-arranged pixels of a current image frame block (i.e., 3 pixels).

First, in the left area a1, assuming that the candidate blocks are numbered from the upper left candidate block horizontally and downwardly in a row-by-row manner, odd-numbered candidate blocks are sequentially processed in the increasing order as shown in FIG. 14(b) (Step 1).

Then, in the left area a1, even-numbered candidate blocks are sequentially processed in the increasing order as shown in FIG. 14(c) (Step 2).

Next, also in the right area a2, odd-numbered candidate blocks (Step 3) and even-numbered candidate blocks (Step 4) are sequentially processed in this order in the same way.

Hereinafter, the operation of the motion vector detecting device 300 according to embodiment 3 of the present invention is described.

First, as in embodiment 2, the pixel data of the current image frame block, which is stored in the current image storage 103, is supplied to the arithmetic unit 116.

Next, the operation of obtaining a series of AEs is described.

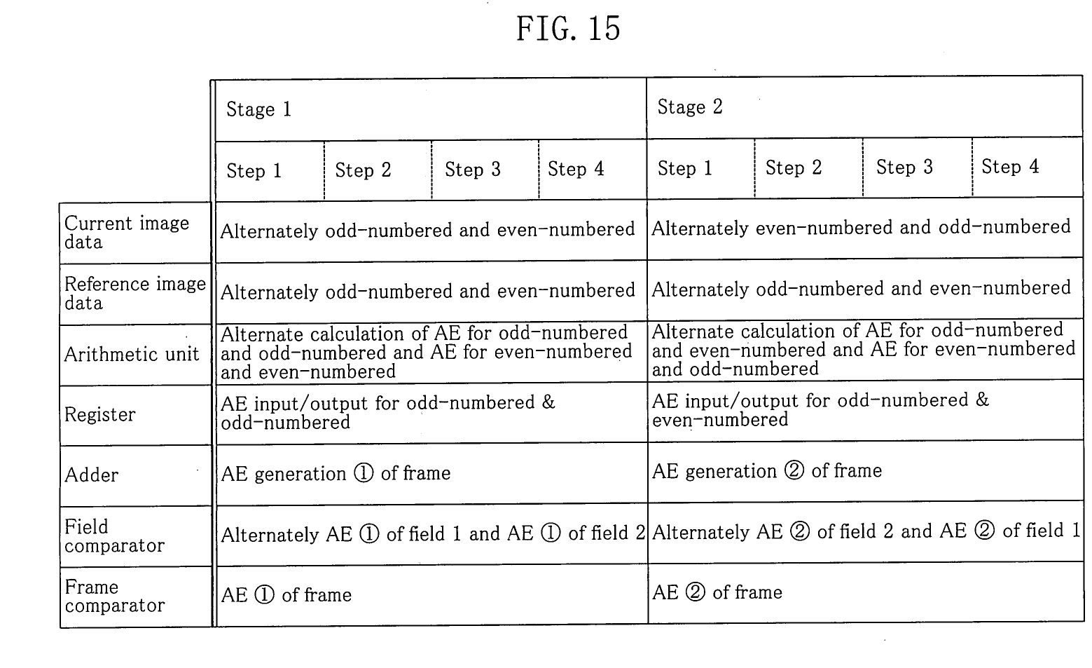

FIG. 15 shows the parity of data of the components included in the motion vector detecting device 300 of embodiment 3 at respective times.

The operation of obtaining a series of AEs is performed through two stages, one for the current image field block and reference image field which have the same parity, and the other for the current image field block and reference image field which have different parities. Hereinafter, the description is provided separately for respective stages.

<Stage 1 (Corresponding to the First Stage)>

At Stage 1, the arithmetic operation is performed on all of search points such that, as for the current image field block and the reference image field, AEs for the combination of odd-numbered fields (the combination to be subjected to the first arithmetic operation) and AEs for the combination of even-numbered fields (the combination to be subjected to the second arithmetic operation) are alternately output as shown in FIG. 15.

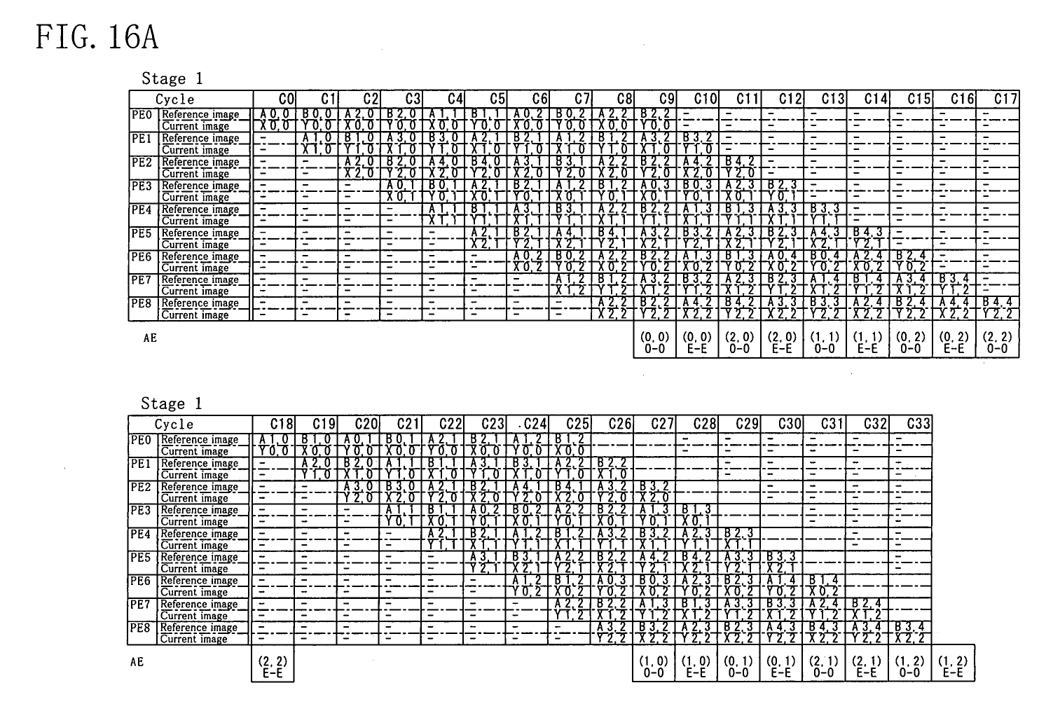

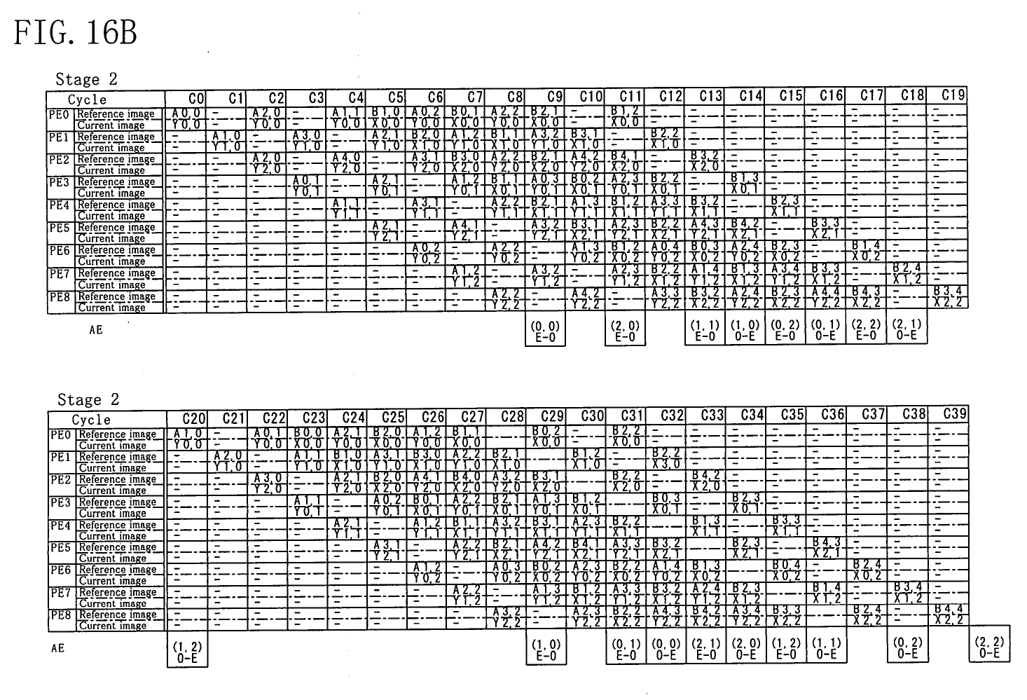

Now, the operation of obtaining a series of AEs is specifically described with reference to FIGS. 16A and 16B.

FIG. 16A illustrates pipeline processing achieved by the arithmetic unit 116 at Steps 1 and 2, wherein data used by the processor elements PE0 to PE8 in respective cycles are shown. The upper part of FIG. 16A illustrates the operation performed at Stage 1, and the lower part of FIG. 16A illustrates the operation performed at Stage 2.

First, the image data controller 115 controls the current image parity selector 313 shown in FIG. 11 such that in the first cycle (C0) the even-numbered processor elements PE in the arithmetic unit 116 use the pixel data of the current image odd-numbered field block (see FIG. 5; please refer to FIG. 5 at every appearance of “current image odd-numbered field block”) which is stored in the current image register 301 as the current image data, and the odd-numbered processor elements PE use the pixel data of the current image even-numbered field block (see FIG. 5; please refer to FIG. 5 at every appearance of “current image even-numbered field block”) which is stored in the current image register 311. Subsequently, the parities of the pixel data used alternate every clock cycle.

Next, supply of the reference image data to the arithmetic unit 116 is described.

In the first cycle (C0), the reference image data of (A0, 0) of the reference image odd-numbered field (see FIG. 5; please refer to FIG. 5 at every appearance of “reference image odd-numbered field”) is supplied from the reference image odd-numbered field storage 101 through the input 213a of the arithmetic unit 116 shown in FIG. 12. In the arithmetic unit 116, the pixel data of (A0, 0) is supplied to the processor element PE0 by the reference image data selection means 215a which is controlled by the reference image controller 211. In the other processor elements PE, the arithmetic operation results are invalidated, and therefore, any input may be selected.

Then, in the second cycle (C1), the reference pixel data of (A1, 0) of the reference image odd-numbered field is supplied from the reference image odd-numbered field storage 101 to the processor element PE1. The pixel data of (B0, 0) of the reference image even-numbered field (see FIG. 5; please refer to FIG. 5 at every appearance of “reference image even-numbered field”) is supplied from the reference image even-numbered field storage 102 to the processor element PE0.

In the third cycle (C2), the pixel data of (A2, 0) of the reference image odd-numbered field is supplied to the processor elements PE0 and PE2 from the reference image odd-numbered field storage 101. The pixel data of (B1, 0) of the reference image even-numbered field is supplied to the processor element PE1 from the reference image even-numbered field storage 102.

Then, in the fourth cycle (C3), the pixel data of (A0,1) and (A3,0) of the reference image odd-numbered field are respectively output through the two outputs of the reference image odd-numbered field storage 101 and supplied to the processor elements PE3 and PE1 through the inputs 213a and 213b of the arithmetic unit 116. On the other hand, (B2,0) of the reference image even-numbered field is output from the reference image even-numbered field storage 102 through the input 214a of the arithmetic unit 116 to the processor elements PE2 and PE0.

In this way, two input lines are provided for each field, whereby a case where two pieces of data are concurrently required is covered. By supplying the reference image data as shown in FIG. 14, the pipeline processing is not interrupted, and the number of pieces of data the arithmetic unit 116 concurrently requires is limited to two at the maximum for each parity.

In the subsequent cycles, the pixel data necessary for the processor elements PE0 to PE8 are sequentially supplied as shown in FIG. 16A, so that the sums of absolute differences of the candidate blocks are accumulated. In this way, the arithmetic operations for different fields are alternately performed by the processor elements PE0 to PE8, whereby as for the combination of odd-numbered fields and the combination of even-numbered fields, the AEs corresponding to these combinations are alternately obtained from the arithmetic unit 116.

In the tenth cycle (C9), the AE of a candidate block corresponding to candidate vector (0, 0) for the combination of odd-numbered fields of the reference image and the current image is output from the arithmetic unit 116. In FIG. 16A, the parity of calculated AE is represented such that a field of an odd number is indicated by “0” and a field of an even number is indicated by “E”. This AE is input to the field comparator 108 and used for obtaining field motion vector MV1 and, on the other hand, is stored in the register 117.

In the eleventh cycle (C10), the AE of a candidate block corresponding to candidate vector (0, 0) for the combination of even-numbered fields of the reference image and the current image is output from the arithmetic unit 116. This AE is input to the field comparator 108 and used for obtaining field motion vector MV2. On the other hand, at the adder 110, this AE is added to the AE for the combination of the odd-numbered fields which is output from the register 117, whereby an AE for one frame corresponding to an even-numbered vertical line is obtained. This AE for one frame is input to the frame comparator 111 and used for obtaining frame motion vector MV.

After the eleventh cycle, the arithmetic operations are performed according to FIG. 16A until the end of the operation of Step 1. Subsequently, the arithmetic operations of Steps 2 to 4 are performed, whereby calculation of AEs at all of the search points for the combinations of the same parities of the current image field block and the reference image field is completed.

<Stage 2 (Corresponding to the Second Stage)>

At Stage 2, arithmetic operation is performed according to FIG. 16B on all of search points for the combinations of the fields of different parities of the current image field block and the reference image field in the search order of four steps as described in Stage 1 as shown in FIG. 15, i.e., the combination of the even-numbered field of the current image field block and the odd-numbered field of the reference image field (the combination corresponding to the third arithmetic operation) and the combination of the odd-numbered field of the current image field block and the even-numbered field of the reference image field (the combination corresponding to the fourth arithmetic operation).

In the case of the combinations where the current image field block and the reference image field have different parities, it is necessary to add together AEs horizontally shifted by one pixel when obtaining AEs on a frame-by-frame basis. Thus, candidate vectors for the uppermost row of the reference image odd-numbered field and the lowermost row of the reference image even-numbered field are not used for calculations of AEs on a frame-by-frame basis. Therefore, there is a period where the arithmetic operation is performed only for one field as shown in FIG. 16B.

Also at Stage 2, the arithmetic operation is performed as described above. Thus, three vectors in total, i.e., frame motion vector MV, field motion vector MV1 and field motion vector MV2, are obtained by the arithmetic operations at Stages 1 and 2.

As described above, according to embodiment 3, the field motion vectors are calculated in a time-division manner based on estimation errors sequentially calculated for respective candidate vectors of an original image block. Thus, it is not necessary to separately provide two circuits which are required for calculation in the conventional example, and accordingly, the hardware size required for calculation of the estimation errors is greatly reduced, and the hardware size required for obtaining the minimum estimation error among the estimation errors calculated on a field-by-field basis is greatly reduced. Furthermore, it is sufficient for calculation of a frame motion vector that only an estimation error for one candidate vector is stored. Therefore, the hardware size can be reduced.

In the above example of embodiment 3, the arithmetic operation is performed at Stage 1 as for the combinations where the current image field block and the reference image field block have the same parity such that the operation for the combination of odd-numbered field and odd-numbered field is performed priorly, and then, the arithmetic operation is performed at Stage 2 as for the combinations where the current image field block and the reference image field block have different parities such that the operation for the combination of even-numbered field and odd-numbered field is performed priorly. However, it is not necessary to perform the operation in the above order.

In embodiments 1-3, three motion vectors in total, i.e., two motion vectors MV1 and MV2 by the field motion compensation estimation in the frame structure and one motion vector MV by frame motion compensation estimation are obtained. However, it is also possible to use data based on the field structure such that three motion vectors in total, i.e., two motion vectors MV1 and MV2 by the 16×8 motion compensation estimation and one motion vector MV by field motion compensation estimation, are obtained.

In the examples described above in embodiments 1-3, the current image block size and the reference image size in the frame structure are 3×6 pixels and 8×10 pixels, respectively. However, the ranges of the current image block size and the reference image are not limited to these specific ranges.

(Embodiment 4)

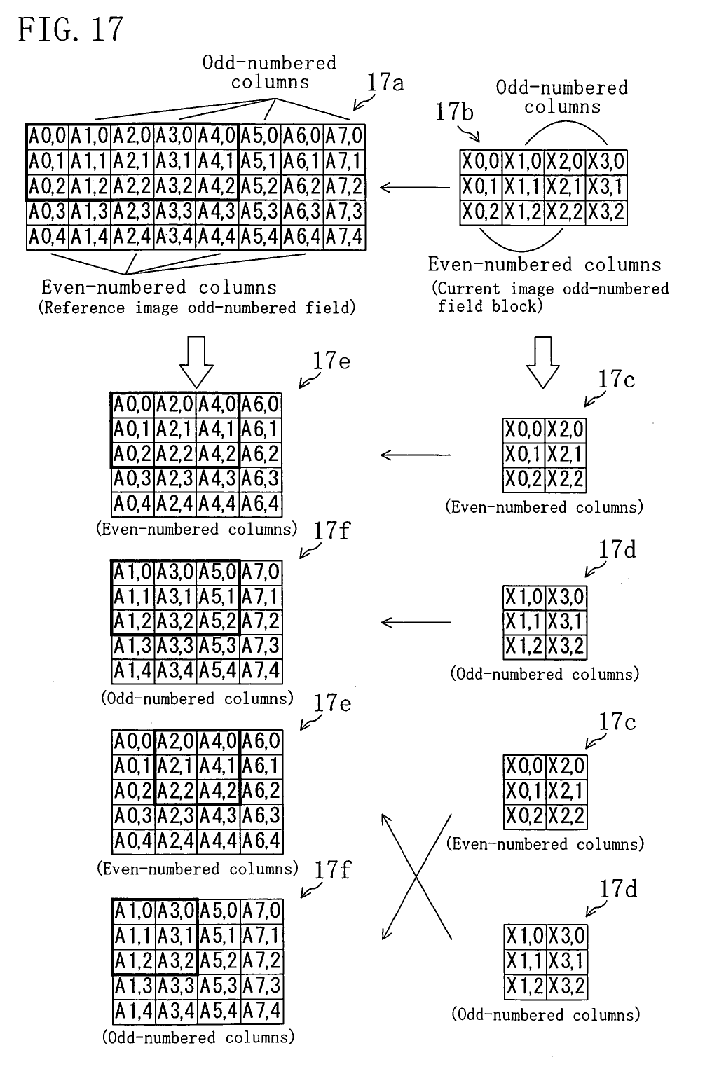

In embodiment 4 described below, only the combination of the odd-numbered field of the current image frame block and the odd-numbered field of the reference image frame as shown in the uppermost part of FIG. 17 is considered for simplicity of illustration, but the present invention is not limited to this combination. In an example described below, as shown in FIG. 17, the block size of a current image odd-numbered field block 17b is 4×3 pixels when defined on a field-by-field basis, the search area is a reference image odd-numbered field 17a of 8×5 pixels, and these areas are thinned at a cycle of two columns with different phases for processing such that each of these areas is divided into two image segments, a segment of even-numbered columns (e.g., 17c and 17e) and a segment of odd-numbered columns (e.g., 17d and 17f). (That is, this case corresponds to a case where n=2 in corresponding claims).

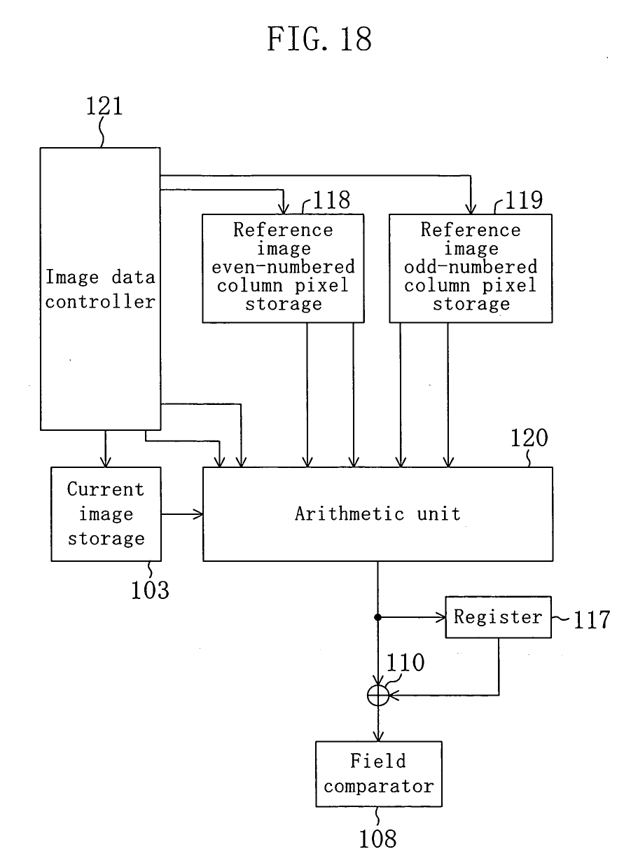

FIG. 18 is a block diagram showing an example of the structure of a motion vector detecting device 400 according to embodiment 4 of the present invention.

The motion vector detecting device 400 shown in FIG. 18 includes a reference image even-numbered column pixel storage 118 (corresponding to a reference image storage), a reference image odd-numbered column pixel storage 119 (corresponding to the reference image storage), an arithmetic unit 120 (corresponding to arithmetic operation means) and an image data controller 121. The other components are the same as those of the motion vector detecting device 300 of embodiment 3.

Since the process is performed separately on two image segments in the example of embodiment 4 as described above, the number of storages for storing reference image data is 2, and the number of registers is 1. The arithmetic unit 120 includes processor elements PE0 to PE5, the number of which is equal to the number of pixels in an image segment obtained by thinning the current image odd-numbered field block 17b, i.e., 6. The internal structure of the arithmetic unit 120 and the processor elements PE0 to PE5 can be realized by the components of FIGS. 11 and 13.

Each of the reference image even-numbered column pixel storage 118 and the reference image odd-numbered column pixel storage 119 outputs two pieces of data, which are supplied to the arithmetic unit 120 as they are. On the other hand, a control signal from the image data controller 121 is input to the arithmetic unit 120.

The arithmetic unit 120 sequentially calculates AE segments for respective candidate vectors corresponding to even-numbered or odd-numbered lines of a candidate block using pipeline processing based on the input reference image data and stored current image data.

In the arithmetic unit 120, even-numbered processor elements PE and odd-numbered processor elements PE operate to alternately perform arithmetic operations on image segments of different columns. With such an operation, the arithmetic unit 120 alternately outputs AEs for combinations of image segments of different columns (hereinafter, referred to as “AE segment”) in such a manner that one AE is output every cycle because the processor elements PE0 to PE8 are arranged in a cascade connection configuration. Each of the output AE segments is temporarily stored in the register 117 as it is.

The AE segment stored in the register 117 is output in the next clock cycle and added in the adder 110 to an AE segment for another combination of image segments in the same block which is output from the arithmetic unit 120, whereby an AE for one field is calculated. The calculated AE for one field is input to the field comparator 108, in which the minimum AE is determined among the AEs calculated on a field-by-field basis.

In this way, the arithmetic operation for one field is thinned by the units of a column, and the arithmetic operation is performed on every region obtained by thinning, such that results of the arithmetic operation are sequentially output, whereby the AE for one field is obtained. Thus, the number of necessary processor elements PE is greatly reduced, and such a reduction results in a reduction of hardware.

Herein, an arithmetic operation for a combination of thinned images is performed through four steps. A combination of odd-numbered column images of a current image odd-numbered field block and a reference image odd-numbered field and a combination of even-numbered column images of the current image odd-numbered field block and the reference image odd-numbered field are considered as one pair.

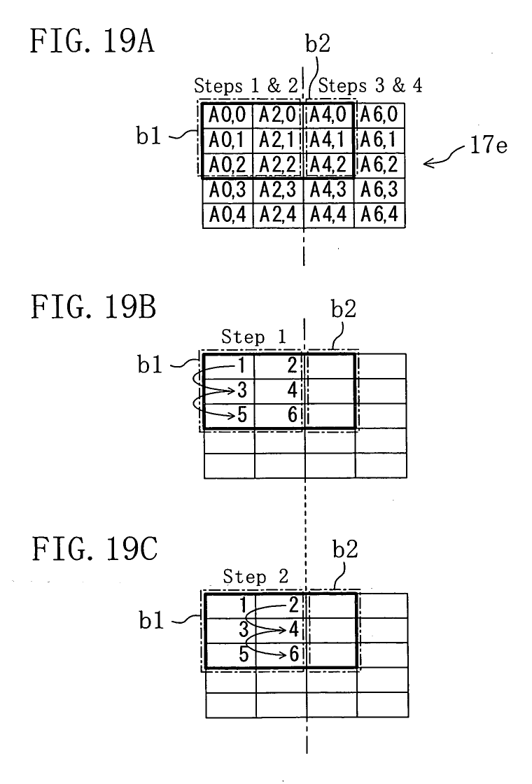

FIGS. 19(a) to 19(c) illustrate the order of search among candidate blocks within a search area where the even-numbered columns 17e of the reference image odd-numbered field 17a shown in FIG. 17 is employed as an example. In the following description, candidate vector (0, 0) with the upper left pixel as a representative point is represented by coordinate (A0, 0). The coordinates of candidate vectors are represented with the assumption that the horizontal rightward direction and vertical downward direction are positive directions.

As shown in FIG. 19(a), the search area is divided into a plurality of regions each of which has a width corresponding to the number of horizontally-arranged pixels of an image segment of a current image odd-numbered field block 17b (e.g., see segments 17c and 17d), i.e., 2 pixels.

First, in the left area b1, assuming that the candidate blocks are numbered from the upper left candidate block horizontally and downwardly in a row-by-row manner, odd-numbered candidate blocks are sequentially processed in the increasing order (Step 1).

Then, in the left area b1, even-numbered candidate blocks are sequentially processed in the increasing order (Step 2).

Next, also in the right area b2, odd-numbered candidate blocks (Step 3) and even-numbered candidate blocks (Step 4) are sequentially processed in this order in the same way.

It should be noted that, in the case where the process regions at Steps 3 and 4 are out of the search area, the process for blocks of such process regions is invalidated.

In embodiment 4, the process is performed separately on two image segments obtained by thinning, such that two parts, i.e., an odd-numbered part and an even-numbered part, are processed at different steps.

Hereinafter, the operation of the motion vector detecting device 400 according to embodiment 4 of the present invention is described.

First, the pixel data of the current image odd-numbered field block 17b, which is stored in the current image storage 103, is supplied to the arithmetic unit 120.

As for the current image data, pixel data [X0,0], [X2,0], [X0,1], [X2,1], [X0,2], and [X2, 2] of the even-numbered columns 17c of the current image odd-numbered field block 17b are stored in the current image registers 301 of the processor elements PE0 to PE5, and pixel data [X1, 0], [X3, 0], [X1, 1], [X3, 1], [X1, 2], and [X3, 2] of the odd-numbered columns of the current image odd-numbered field block 17b are stored in the current image registers 311 of the processor elements PE0 to PE5. The stored pixel data are retained till the calculation of a series of AEs is completed.

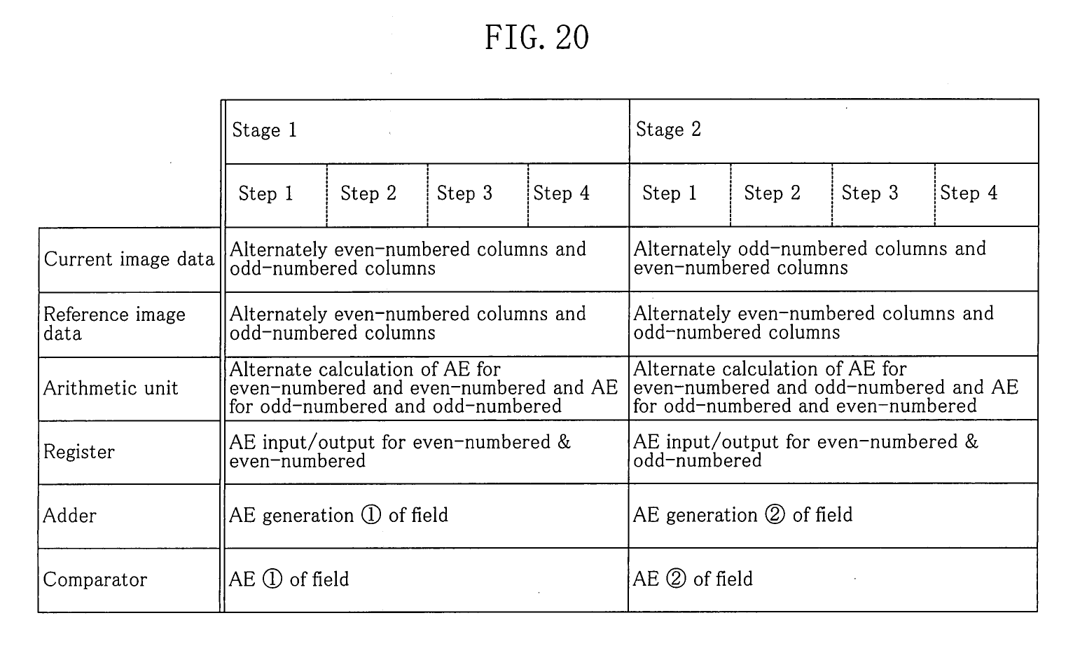

Next, a series of arithmetic operations are described with reference to FIG. 20.

FIG. 20 shows data of the components included in the motion vector detecting device 400 of embodiment 4 at respective times. Hereinafter, the arithmetic operation is performed through two stages.

<Stage 1 (Corresponding to the First Stage)>

In the first place, as shown in FIG. 17, the arithmetic operation is performed on all of search points such that AE segments for the combination of even-numbered column images (17c, 17e) of the current image odd-numbered field block and the reference image odd-numbered field (the combination to be subjected to the second arithmetic operation) and AE segments for the combination of odd-numbered column images (17d, 17f) of the current image odd-numbered field block and the reference image odd-numbered field (the combination to be subjected to the first arithmetic operation) are alternately output.

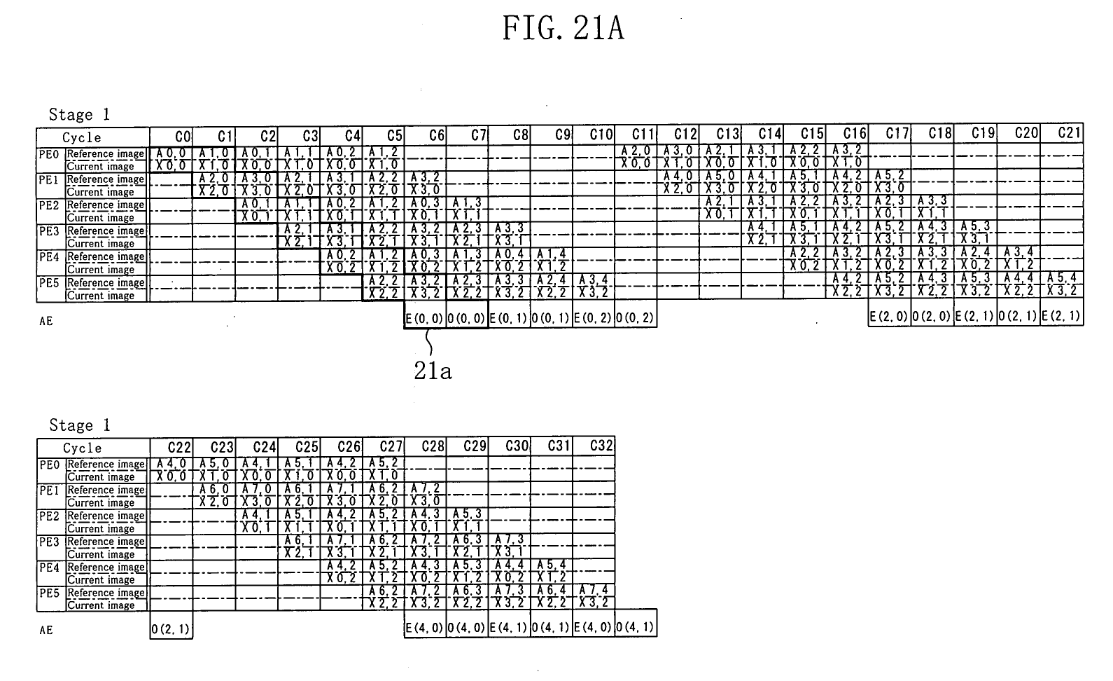

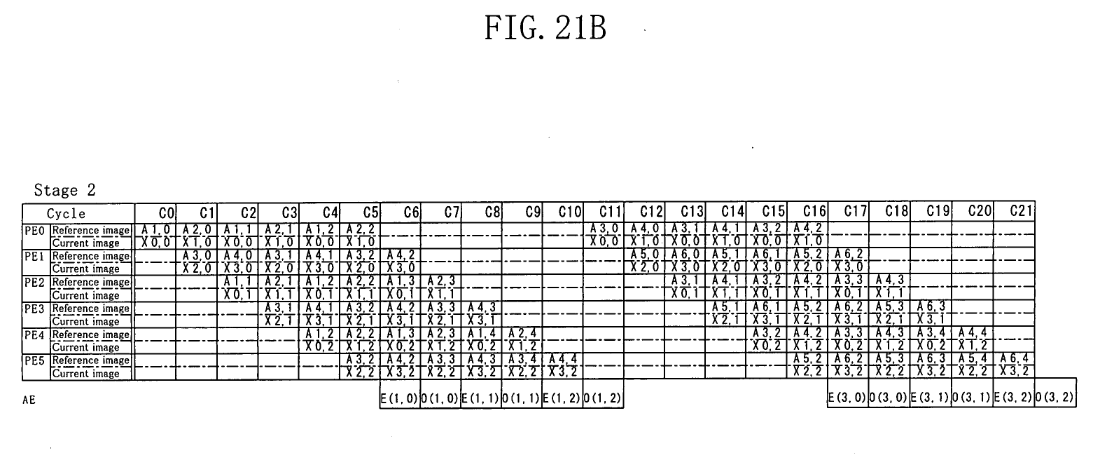

Now, the operation of obtaining a series of AEs is specifically described with reference to FIGS. 21A and 21B.

FIGS. 21A and 21B illustrate pipeline processing achieved by the arithmetic unit 120, wherein data used by the processor elements PE0 to PE5 in respective cycles are shown.

First, the image data controller 121 controls the selection means 311 such that in the first cycle (C0), the even-numbered processor elements PE in the arithmetic unit 120 use as the current image data the pixel data of the even-numbered columns 17c of the current image odd-numbered field block 17b which is stored in the register 301. The odd-numbered processor elements PE use as the current image data the pixel data of the odd-numbered columns 17d of the current image odd-numbered field block 17b which is stored in the register 301. Subsequently, the pixel data to be used alternate every clock cycle.

Next, supply of the reference image data to the arithmetic unit 120 is described.

In the first cycle (C0), the pixel data of (A0, 0) is supplied from the reference image even-numbered column pixel storage 118 to the processor element PE0 of the arithmetic unit 120 through the input 213a. In the other processor elements PE, the arithmetic operation results are invalidated, and therefore, any input may be selected.

Then, in the second cycle (C1), the reference pixel data of (A2, 0) is supplied from the reference image even-numbered column pixel storage 118 to the processor element PE1. The pixel data of (A1, 0) is supplied from the reference image odd-numbered column pixel storage 119 to the processor element PE0.

In the third cycle (C2), the pixel data of (A0, 1) is supplied from the reference image even-numbered column pixel storage 118 to the processor elements PE0 and PE2. The pixel data of (A3, 0) is supplied from the reference image odd-numbered column pixel storage 119 to the processor element PE1.

In the subsequent cycles, the pixel data necessary for the processor elements PE0 to PE5 are sequentially supplied as shown in FIG. 21A, so that the sums of absolute differences of the thinned candidate blocks (AE segments) are accumulated.

In this way, the arithmetic operations for different segmental regions are alternately performed by the processor elements PE0 to PE5, whereby as for the combination of odd-numbered columns and the combination of even-numbered columns, the AE segments corresponding to these combinations are alternately obtained from the arithmetic unit 120.

As a result of the arithmetic operation, in the seventh cycle (C6), the AE segment of an even-numbered column of a candidate block corresponding to candidate vector (0, 0) is output from the arithmetic unit 120. This AE segment is stored in the register 117. In FIG. 21A, an AE segment for the even-numbered column 17c of the current image odd-numbered field block 17b is indicated by “E” and an AE segment for the odd-numbered columns 17d of the current image odd-numbered field block 17b is indicated by “0”.

In the eighth cycle (C7), the AE segment of a candidate block corresponding to candidate vector (0, 0) for the combination of odd-numbered columns is output from the arithmetic unit 120. This AE segment is added to an AE segment for an even-numbered column which is output from the register 117, whereby an AE for a field is obtained. This AE is input to the field comparator 108 and used for obtaining a field motion vector.

In this way, an AE corresponding to one candidate vector is calculated based on combinations of even-numbered columns and odd-numbered columns. It should be noted that in FIG. 21A a portion 21a enclosed by a thick line indicates calculation of the AE for candidate vector (0, 0).

After the eighth cycle, the arithmetic operations are performed according to FIG. 21A until the end of the operation of Step 1. Subsequently, the arithmetic operation of Step 2 is performed, whereby calculation of AEs at all of the search point for the combinations of the same parity columns of the current image odd-numbered field block 17b and the reference image odd-numbered field 17a is completed.

<Stage 2 (Corresponding to the Second Stage)>

Subsequently, the arithmetic operation is performed according to FIG. 21B in the same search order as that employed at Stage 1 as shown in FIG. 20 for the combination of odd-numbered columns and even-numbered columns (the combination subjected to the fourth arithmetic operation) and the combination of even-numbered columns and odd-numbered columns (the combination subjected to the third arithmetic operation) of the current image odd-numbered field block 17b and the reference image odd-numbered field 17a, whereby the arithmetic operation on all of the search area is completed, and a field motion vector is obtained.

As described above, according to the motion vector detecting device of embodiment 4, image segments of the even-numbered columns 17e and odd-numbered columns 17f of the reference image odd-numbered field 17a are used to sequentially calculate estimation errors of respective candidate vectors for image segments of the even-numbered columns 17c and odd-numbered columns 17d of the current image odd-numbered field block 17b, whereby a field motion vector is calculated in a time-division manner. Thus, the circuits required for calculation is half that required in the conventional example, and the hardware size required for calculation of estimation errors is greatly reduced. Furthermore, the hardware size of a field comparator which is required for obtaining the minimum estimation errors from among the estimation errors calculated on a field-by-field basis is greatly reduced.

A series of arithmetic operations for a combination of even-numbered columns of the current image odd-numbered field block 17b and even-numbered columns of a reference image odd-numbered field at Stage 1 of embodiment 4 is equivalent to an arithmetic operation which is performed on every other pixel in a horizontal direction. Thus, such a thinned version of the arithmetic operation is realized without making any major modification to circuitry.

In embodiment 4, the current image odd-numbered field block 17b and the reference image odd-numbered field 17a are each thinned into two image segments of even-numbered columns and odd-numbered columns. However, the current image odd-numbered field block 17b and the reference image odd-numbered field 17a may be thinned by the units of a row. Furthermore, the present invention is not limited to the method for thinning an image into two image segments. In such a case, it is only necessary to provide a number of registers which corresponds to the number of image segments obtained by thinning.

In embodiment 4, at Stage 1, as for the combinations of columns of the same parity of the current image odd-numbered field block 17b and the reference image odd-numbered field 17a, the arithmetic operation is performed priorly for the combination of odd-numbered columns and odd-numbered columns, and then at Stage 2, as for the combinations of columns of different parities, the arithmetic operation is performed priorly for the combination of even-numbered columns and odd-numbered columns. However, it is not necessary to perform the arithmetic operation according to the above order.

In embodiments 1-4, the present invention has been described with an example of the frame structure. However, the present invention is applicable to the field structure.

In embodiments 1-4, for the purpose of reducing waste of the pipeline processing, each of two storages for storing reference image data has two outputs. Accordingly, in embodiments 1 and 2, two selection means for selecting the parity of the reference image data are provided. However, the number of outputs of the storage and the number of selection means may be one if there is some room in the process time.

In embodiments 1-4, the sum of absolute differences of pixel data between a reference image frame block and a current image frame block is used as AE, i.e., as an evaluation index of the degree of correlation. However, the sum of squared differences may be used as AE.

(Embodiment 5)

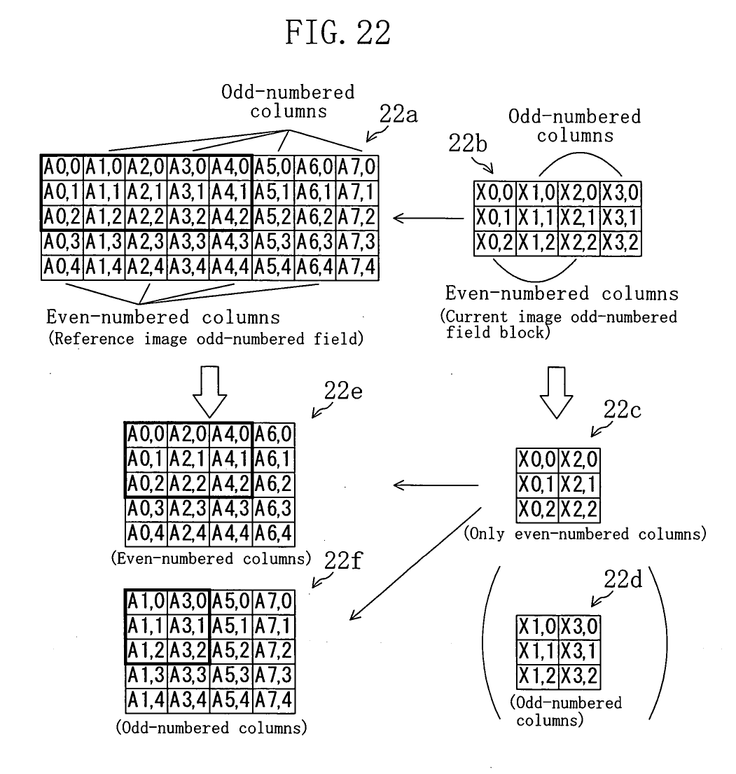

In embodiment 5 described below, only the combination of the odd-numbered field of the current image frame block and the odd-numbered field of the reference image frame as shown in the uppermost part of FIG. 22 is considered for simplicity of illustration, but the present invention is not limited to this combination. In an example described below, as shown in FIG. 22, the block size of a current image odd-numbered field block 22b is 4×3 pixels when defined on a field-by-field basis, the search area is a reference image odd-numbered field 22a of 8×5 pixels, and these areas are thinned at a cycle of two columns with different phases for processing such that each of these areas is divided into two image segments, a segment of even-numbered columns (e.g., 22c and 22e) and a segment of odd-numbered columns (e.g., 22d and 22f). (That is, this case corresponds to a case where n=2 in corresponding claims). Furthermore, in the example described below, only the pixel data of the even-numbered columns 22c among the image segments of the current image odd-numbered field block 22b is used, but the present invention is not limited to this example.

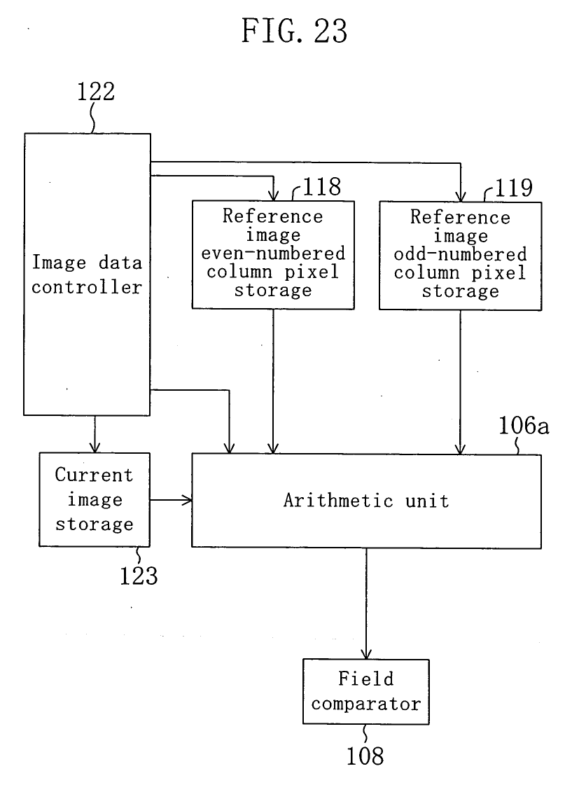

FIG. 23 is a block diagram showing an example of the structure of a motion vector detecting device 500 according to embodiment 5 of the present invention.

The motion vector detecting device 500 shown in FIG. 23 includes an image data controller 122, a current image storage 123, an arithmetic unit 106a (corresponding to arithmetic operation means), a reference image even-numbered column pixel storage 118 (corresponding to a reference image storage), a reference image odd-numbered column pixel storage 119 (corresponding to the reference image storage), and a field comparator 108. The current image storage 123 stores only the pixel data of the even-numbered columns 22c of the current image odd-numbered field block 22b. The reference image even-numbered column pixel storage 118 (corresponding to a reference image storage), the reference image odd-numbered column pixel storage 119 (corresponding to the reference image storage) and the field comparator 108 are the same as those of embodiment 4.

Since the process is performed separately on two image segments in the example of embodiment 5 as described above, the number of storages for storing reference image data is 2, and the number of registers is 1. The arithmetic unit 106a has a structure similar to that of the arithmetic unit of embodiment 1 but includes processor elements PE0 to PE5, the number of which is equal to the number of pixels in an image segment obtained by thinning the current image odd-numbered field block 22b, i.e., 6. The internal structure of the arithmetic unit 106a and the processor elements PE0 to PE5 can be realized by the components of FIGS. 2 and 3, respectively.

The reference image controller 201 (see FIG. 2) controls reference image data which is supplied to the processor elements PE0 to PE5. Furthermore, the current image controller 202 (see FIG. 2) controls current image data which is input to the processor elements PE0 to PE5.

Each of the reference image even-numbered column pixel storage 118 and the reference image odd-numbered column pixel storage 119 outputs two pieces of data, which are supplied to the arithmetic unit 106a as they are. On the other hand, a control signal from the image data controller 122 is input to the arithmetic unit 106a.

The arithmetic unit 106a sequentially calculates AE segments for respective candidate vectors corresponding to even-numbered or odd-numbered lines of a candidate block using pipeline processing based on the input reference image data and stored current image data.

Among the AE segments sequentially calculated by the arithmetic unit 106a, an AE having the minimum value is selected by the field comparator 108.

Herein, an arithmetic operation for a combination of image segments obtained by thinning is performed through two steps.

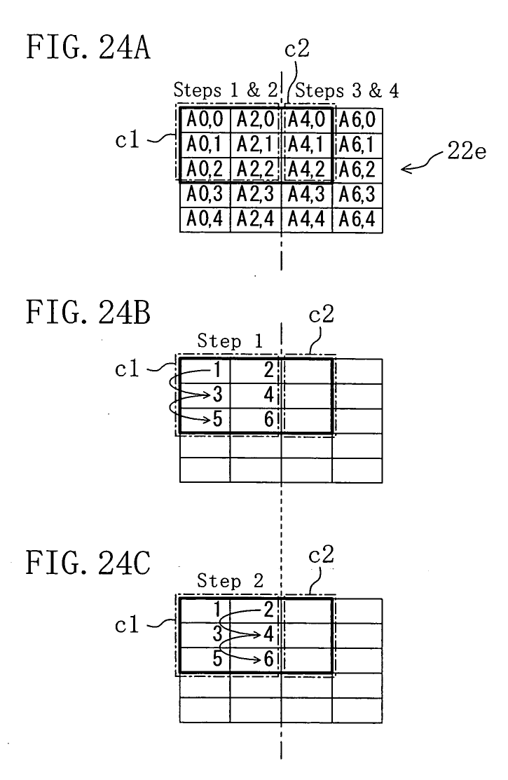

FIGS. 24(a) to 24(c) illustrate the order of search among candidate blocks within a search area where the even-numbered columns 22e of the reference image odd-numbered field 22a shown in FIG. 22 is employed as an example. In the following description, candidate vector (0, 0) with the upper left pixel as a representative point is represented by coordinate (A0, 0). The coordinates of candidate vectors are represented with the assumption that the horizontal rightward direction and vertical downward direction are positive directions.

As shown in FIG. 24(a), the search area is divided into a plurality of regions each of which has a width corresponding to the number of horizontally-arranged pixels of an image segment of a current image odd-numbered field block 22b (e.g., see segment 22c), i.e., 2 pixels.

First, in the left area c1, assuming that the candidate blocks are numbered from the upper left candidate block horizontally and downwardly in a row-by-row manner, odd-numbered candidate blocks are sequentially processed in the increasing order (Step 1).

Then, in the left area c1, even-numbered candidate blocks are sequentially processed in the increasing order (Step 2).

Next, also in the right area c2, odd-numbered candidate blocks (Step 3) and even-numbered candidate blocks (Step 4) are sequentially processed in this order in the same way.

It should be noted that, in the case where the process regions at Steps 3 and 4 are out of the search area, the process for blocks of such process regions is invalidated.

Hereinafter, the operation of the motion vector detecting device 500 according to embodiment 5 of the present invention is described.

First, the pixel data of the even-numbered columns 22c of the current image odd-numbered field block 22b, which are stored in the current image storage 123, are supplied to the arithmetic unit 106a.

As for the current image data, pixel data [XO,O], [X2,O], [XO,1], [X2,1], [XO,2], and [X2, 2] of the even-numbered columns 22c of the current image odd-numbered field block 22b are stored in the current image registers 301 (see FIG. 3) of the processor elements PE0 to PE5 and retained till the calculation of a series of AEs is completed.

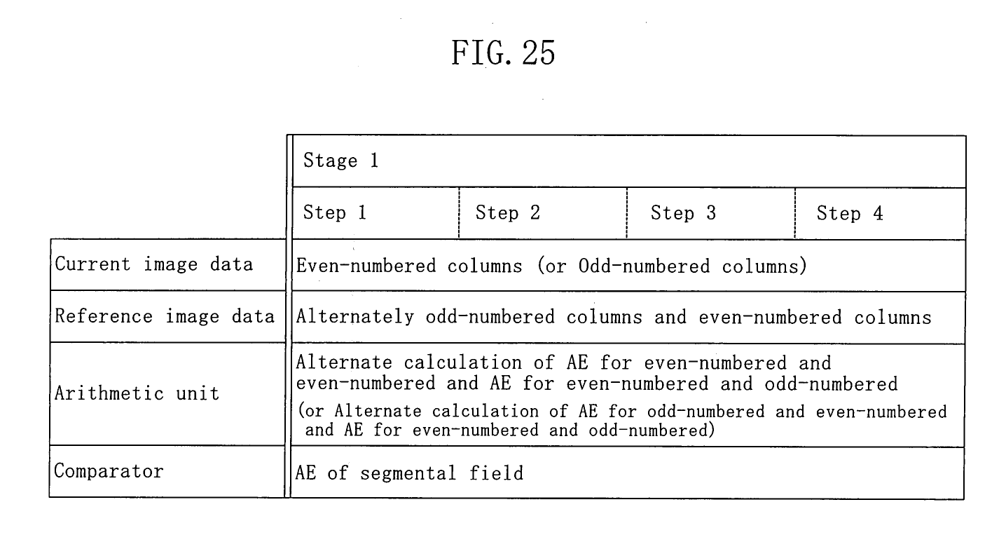

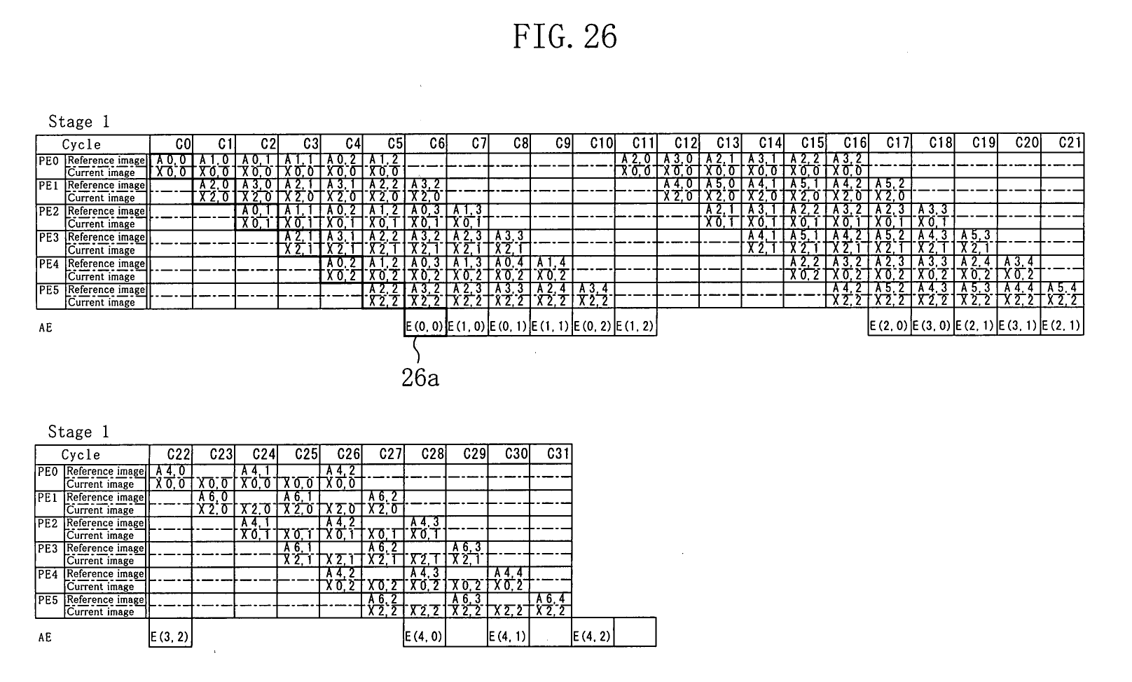

Next, a series of arithmetic operations are described with reference to FIGS. 25 and 26.

FIG. 25 shows data of the components included in the motion vector detecting device 500 of embodiment 5 at respective times.

FIG. 26 shows data of the components included in the motion vector detecting device 500 of embodiment 5 at respective times.

Now, the operation of obtaining a series of AEs is specifically described with reference to FIG. 26.

FIG. 26 illustrates pipeline processing achieved by the arithmetic unit 106a, wherein data used by the processor elements PE0 to PE5 in respective cycles are shown.

In the first cycle (C0), the pixel data of (A0, 0) is supplied from the reference image even-numbered column pixel storage 118 to the processor element PE0 of the arithmetic unit 106a through the input 204 (see FIG. 2). In the other processor elements PE, the arithmetic operation results are invalidated, and therefore, any input may be selected.

Then, in the second cycle (C1), the pixel data of (A2, 0) is supplied from the reference image even-numbered column pixel storage 118 to the processor element PE1. The pixel data of (A1, 0) is supplied from the reference image odd-numbered column pixel storage 119 to the processor element PE0.

In the third cycle (C2), the pixel data of (A0, 1) is supplied from the reference image even-numbered column pixel storage 118 to the processor elements PE0 and PE2.

The pixel data of (A3, 0) is supplied from the reference image odd-numbered column pixel storage 119 to the processor element PE1.

In the subsequent cycles, the pixel data necessary for the processor elements PE0 to PE5 are sequentially supplied as shown in FIG. 26, so that the sums of absolute differences of the thinned candidate blocks are accumulated.

In this way, the arithmetic operations for different segmental regions are alternately performed by the processor elements PE0 to PE5, whereby as for the combination of the even-numbered columns 22c of the current image odd-numbered field block 22b and the even-numbered columns 22e of the reference image odd-numbered field 22a and the combination of the even-numbered columns 22c of the current image odd-numbered field block 22b and the odd-numbered columns 22f of the reference image odd-numbered field 22a, the AE segments corresponding to these combinations are alternately obtained from the arithmetic unit 106a.

As a result of the arithmetic operation, in the seventh cycle (C6), the AE segment of an even-numbered column of a candidate block corresponding to candidate vector (0, 0) is output from the arithmetic unit 106a. This AE segment is input to the field comparator 108 as it is and used for obtaining a field motion vector. In FIG. 26, an AE segment for the even-numbered column 22c of the current image odd-numbered field block 22b is indicated by “E”. In FIG. 26, a portion 26a enclosed by a thick line indicates calculation of AE segments for candidate vector (0, 0).

After the seventh cycle, the arithmetic operations are performed according to FIG. 26 until the end of the operation of Step 1. Subsequently, the arithmetic operations of Steps 2 and 3 are performed, whereby calculation of AEs at all of the search point for the above-described combinations of the current image odd-numbered field block 22b and the reference image odd-numbered field 22a is completed. In embodiment 5, the arithmetic operation of Step 4 is not performed because the number of the even-numbered columns 22e of the reference image odd-numbered field 22a is an odd number.

As described above, according to the motion vector detecting device of embodiment 5, image segments of the even-numbered columns 22e and odd-numbered columns 22f of the reference image odd-numbered field 22a are used to sequentially calculate estimation errors of respective candidate vectors for image segments of the even-numbered columns 22c of the current image odd-numbered field block 22b, whereby a field motion vector is calculated in a time-division manner. Thus, it is not necessary to separately provide two circuits for calculation which are required in the conventional example. Accordingly, the hardware size required for calculation of estimation errors is greatly reduced. Furthermore, the hardware size of a field comparator which is required for obtaining the minimum estimation error from among the estimation errors calculated on a field-by-field basis is greatly reduced. Therefore, the combinations for the arithmetic operation is reduced, while a high operation efficiency is retained. As a result, simplified motion vector detection is realized without changing the position accuracy of motion vectors. Thus, the process time required for detecting motion vectors can be reduced to about a half.

It should be noted that a series of arithmetic operations for a combination of the even-numbered columns of the current image odd-numbered field block 22b and the reference image odd-numbered field 22a (see 22c and 22e) is equivalent to an arithmetic operation which is performed on every other pixel in a horizontal direction. Thus, such a thinned version of the arithmetic operation is realized without making any major modification to circuitry.

In embodiment 5, the current image odd-numbered field block 22b and the reference image odd-numbered field 22a are each thinned into two image segments of even-numbered columns and odd-numbered columns. However, the current image odd-numbered field block 22b and the reference image odd-numbered field 22a may be thinned by the units of a row. Furthermore, the present invention is not limited to the method for thinning an image into two image segments.

In embodiments 1-5, the present invention has been described with an example of the frame structure. However, the present invention can be applied to the field structure.

### INDUSTRIAL APPLICABILITY

According to a motion vector detecting device and a motion vector detecting method of the present invention, field motion vectors are calculated in a time-division manner based on estimation errors sequentially calculated for respective candidate vectors of an original image block. Thus, it is not necessary to separately provide two circuits for calculation, which are required in the conventional example. Accordingly, the hardware size required for calculation of the estimation errors is greatly reduced, and the hardware size of a field comparator that is required for obtaining the minimum estimation error from among the estimation errors calculated on a field-by-field basis is greatly reduced. Therefore, it is effective to use the motion vector detecting device and the motion vector detecting method of the present invention in a motion picture encoding device.

1. A motion vector detecting device for detecting as a motion vector a candidate vector which minimizes an estimation error for a current image block in a current image frame with respect to a reference image frame, comprising:
a reference image odd-numbered field storage for storing and outputting pixel data of an odd-numbered field which is a constituent of the reference image frame;
a reference image even-numbered field storage for storing and outputting pixel data of an even-numbered field which is a constituent of the reference image frame;
a current image storage for storing and outputting pixel data of the current image block;
an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage;
a field comparator for storing the estimation error calculated by the arithmetic operation means and comparing an estimation error newly calculated by the arithmetic operation means with the estimation error previously stored in the field comparator to retain the smaller estimation error and detect a field motion vector based on a minimum estimation error;
an AE storage for storing a plurality of estimation errors calculated by the arithmetic operation means for one of combinations of an odd-numbered or even-numbered field of the reference image frame and an odd-numbered or even-numbered field of the current image block;
an adder for adding together an estimation error calculated by the arithmetic operation means for a combination corresponding to the one combination and a corresponding one of the plurality of estimation errors stored in the AE storage to calculate an estimation error on a frame-by-frame basis; and
a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

2. The motion vector detecting device of claim 1, wherein:
the arithmetic operation means performs
a first arithmetic operation of calculating estimation errors between the odd-numbered field of the reference image frame and the odd-numbered field of the current image block,
a second arithmetic operation of calculating estimation errors between the even-numbered field of the reference image frame and the even-numbered field of the current image block,
a third arithmetic operation of calculating estimation errors between the odd-numbered field of the reference image frame and the even-numbered field of the current image block, and
a fourth arithmetic operation of calculating estimation errors between the even-numbered field of the reference image frame and the odd-numbered field of the current image block,
the third and fourth arithmetic operations being performed before or after the first and second arithmetic operations;
the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and
the field comparator detects a second field motion vector based on the minimum one of the estimation errors calculated through the second arithmetic operation by the arithmetic operation means and the minimum one of the estimation errors calculated through the third arithmetic operation by the arithmetic operation means;
the AE storage stores estimation errors calculated through any of the first to fourth arithmetic operations by the arithmetic operation means;
the adder performs
a first addition of adding together the estimation errors calculated through the first arithmetic operation and the estimation errors calculated through the second arithmetic operation, and
a second addition of adding together the estimation errors calculated through the third arithmetic operation and the estimation errors calculated through the fourth arithmetic operation; and
the frame comparator detects the frame motion vector based on a result of the first addition of the adder and a result of the second addition of the adder.

3. A motion vector detecting device for detecting as a motion vector a candidate vector which minimizes an estimation error for a current image block in a current image frame with respect to a reference image frame, comprising:
a reference image odd-numbered field storage for storing and outputting pixel data of an odd-numbered field which is a constituent of the reference image frame;
a reference image even-numbered field storage for storing and outputting pixel data of an even-numbered field which is a constituent of the reference image frame;
a current image storage for storing and outputting pixel data of the current image block; and
an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage,
wherein the current image storage further stores a plurality of estimation errors calculated by the arithmetic operation means for one of combinations of an odd-numbered or even-numbered field of the reference image frame and an odd-numbered or even-numbered field of the current image block by overwriting the pixel data of the current image block,
the motion vector detecting device further comprising:
a field comparator for storing the estimation error calculated by the arithmetic operation means and comparing an estimation error newly calculated by the arithmetic operation means with the estimation error previously stored in the field comparator to retain the smaller estimation error and detect a field motion vector based on a minimum estimation error;
an adder for adding together an estimation error calculated by the arithmetic operation means for a combination corresponding to the one combination and a corresponding one of the plurality of estimation errors stored in the current image storage to calculate an estimation error on a frame-by-frame basis; and
a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

4. The motion vector detecting device of claim 3, wherein:
the arithmetic operation means performs
a first arithmetic operation of calculating estimation errors between the odd-numbered field of the reference image frame and the odd-numbered field of the current image block,
a second arithmetic operation of calculating estimation errors between the even-numbered field of the reference image frame and the even-numbered field of the current image block,
a third arithmetic operation of calculating estimation errors between the odd-numbered field of the reference image frame and the even-numbered field of the current image block, and
a fourth arithmetic operation of calculating estimation errors between the even-numbered field of the reference image frame and the odd-numbered field of the current image block,
the third and fourth arithmetic operations being performed before or after the first and second arithmetic operations;
the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and
the field comparator detects a second field motion vector based on the minimum one of the estimation errors calculated through the second arithmetic operation by the arithmetic operation means and the minimum one of the estimation errors calculated through the third arithmetic operation by the arithmetic operation means;
the current image storage stores estimation errors calculated through any of the first to fourth arithmetic operations by the arithmetic operation means by overwriting the pixel data of the current image block;
the adder performs
a first addition of adding together the estimation errors calculated through the first arithmetic operation and the estimation errors calculated through the second arithmetic operation, and
a second addition of adding together the estimation errors calculated through the third arithmetic operation and the estimation errors calculated through the fourth arithmetic operation; and
the frame comparator detects the frame motion vector based on a result of the first addition of the adder and a result of the second addition of the adder.

5. A motion vector detecting device for detecting as a motion vector a candidate vector which minimizes an estimation error for a current image block in a current image frame with respect to a reference image frame, comprising:
a reference image odd-numbered field storage for storing and outputting pixel data of an odd-numbered field which is a constituent of the reference image frame;
a reference image even-numbered field storage for storing and outputting pixel data of an even-numbered field which is a constituent of the reference image frame;
a current image storage for storing and outputting pixel data of the current image block;
an arithmetic operation means for sequentially calculating estimation errors for respective candidate vectors of the current image block based on the pixel data of the odd-numbered field from the reference image odd-numbered field storage or the pixel data of the even-numbered field from the reference image even-numbered field storage and pixel data of an odd-numbered or even-numbered field of the current image block from the current image storage;
a field comparator for storing the estimation error calculated by the arithmetic operation means and comparing an estimation error newly calculated by the arithmetic operation means with an estimation error previously stored in the field comparator to retain the smaller estimation error and detect a field motion vector based on a minimum estimation error;
a register for storing estimation errors for one candidate vector which are calculated by the arithmetic operation means for one of combinations of an odd-numbered or even-numbered field of the reference image frame and an odd-numbered or even-numbered field of the current image block;
an adder for adding together an estimation error calculated by the arithmetic operation means for a combination corresponding to the one combination and the estimation error stored in the register to calculate an estimation error on a frame-by-frame basis; and
a frame comparator for storing the estimation error calculated by the adder on a frame-by-frame basis and comparing an estimation error newly calculated by the adder with the estimation error previously stored in the frame comparator to retain the smaller estimation error and detect a frame motion vector based on the minimum estimation error.

6. The motion vector detecting device of claim 5, wherein:
the arithmetic operation means performs
a first stage where a first arithmetic operation of calculating estimation errors between the odd-numbered field of the reference image frame and the odd-numbered field of the current image block and a second arithmetic operation of calculating estimation errors between the even-numbered field of the reference image frame and the even-numbered field of the current image block are alternately performed, and
a second stage where a third arithmetic operation of calculating estimation errors between the odd-numbered field of the reference image frame and the even-numbered field of the current image block and a fourth arithmetic operation of calculating estimation errors between the even-numbered field of the reference image frame and the odd-numbered field of the current image block are alternately performed,
the second stage being performed before or after the first stage;
the field comparator detects a first field motion vector based on the minimum one of the estimation errors calculated through the first arithmetic operation by the arithmetic operation means and the minimum one of the estimation errors calculated through the fourth arithmetic operation by the arithmetic operation means, and
the field comparator detects a second field motion vector based on the minimum one of the estimation errors calculated through the second arithmetic operation by the arithmetic operation means and the minimum one of the estimation errors calculated through the third arithmetic operation by the arithmetic operation means;
the register stores estimation errors for the one candidate vector which are calculated through any of the first to fourth arithmetic operations by the arithmetic operation means;
the adder performs
a first addition of adding together the estimation errors calculated through the first arithmetic operation and the estimation errors calculated through the second arithmetic operation, and
a second addition of adding together the estimation errors calculated through the third arithmetic operation and the estimation errors calculated through the fourth arithmetic operation; and
the frame comparator detects the frame motion vector based on a result of the first addition of the adder and a result of the second addition of the adder.

7. A motion vector detecting device for detecting as a motion vector a candidate vector which minimizes an estimation error for a current image block in a current image frame with respect to a reference image frame, comprising:
n reference image storages for storing and outputting pixel data of image segments obtained by thinning a field that is a constituent of the reference image frame at a cycle of n columns or n rows (where n is a natural number equal to or greater than 2);
a current image storage for storing and outputting pixel data of the current image block;
an arithmetic operation means for calculating estimation errors for respective candidate vectors of image segments of the current image block based on the pixel data of the image segments from the n reference image storages and pixel data of the image segments of the current image block, the image segments of the current image block being obtained by thinning the current image block from the current image storage at a cycle of n columns or n rows;
registers for storing estimation errors for one candidate vector which are calculated by the arithmetic operation means for one of combinations of the image segments obtained by thinning the field which is a constituent of the reference image frame at a cycle of n columns or n rows and the image segments obtained by thinning the current image block at a cycle of n columns or n rows, the number of the registers being corresponding to the number of the combinations;
an adder for adding together an estimation error calculated by the arithmetic operation means for a combination corresponding to the one combination and the estimation error for the one candidate vector which is stored in the register to calculate an estimation error on a field-by-field basis; and
a frame comparator for storing the estimation error calculated by the adder on a field-by-field basis and comparing an estimation error newly calculated by the adder and the estimation error previously stored in the frame comparator to retain the smaller, estimation error and detect a field motion vector based on the minimum estimation error.

8. The motion vector detecting device of claim 7, wherein:
the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame;
the arithmetic operation means performs
a first stage where a first arithmetic operation of calculating estimation errors between the odd-numbered columns of the field which is a constituent of the reference image frame and odd-numbered columns of the current image block and a second arithmetic operation of calculating estimation errors between the even-numbered columns of the field which is a constituent of the reference image frame and even-numbered columns of the current image block are alternately performed, and
a second stage where a third arithmetic operation of calculating estimation errors between the odd-numbered columns of the field which is a constituent of the reference image frame and even-numbered columns of the current image block and a fourth arithmetic operation of calculating estimation errors between the even-numbered columns of the field which is a constituent of the reference image frame and odd-numbered columns of the current image block are alternately performed,
the second stage being performed before or after the first stage;
the registers, the number of which corresponds to the number of combinations, include one register for storing an estimation error for one candidate vector which is calculated through any of the first to fourth arithmetic operations by the arithmetic operation means;
the adder performs
a first addition of adding together the estimation errors calculated through the first arithmetic operation and the estimation errors calculated through the second arithmetic operation, and
a second addition of adding together the estimation errors calculated through the third arithmetic operation and the estimation errors calculated through the fourth arithmetic operation; and
the field comparator detects the field motion vector based on a result of the first addition of the adder and a result of the second addition of the adder.

9. A motion vector detecting device for detecting as a motion vector a candidate vector which minimizes an estimation error for a current image block in a current image frame with respect to a reference image frame, comprising:
n reference image storages for storing and outputting pixel data of image segments obtained by thinning a field that is a constituent of the reference image frame at a cycle of n columns or n rows (where n is a natural number equal to or greater than 2);
a current image storage for storing and outputting pixel data of image segments obtained by thinning a field which is a constituent of the current image block at a cycle of n columns or n rows;
an arithmetic operation means for calculating estimation errors for respective candidate vectors of the image segments of the current image block based on the pixel data of the image segments from the n reference image storages and pixel data of the image segments from the current image storage; and
a field comparator for comparing an estimation error calculated by the arithmetic operation means and a previously stored estimation error to retain the smaller estimation error and detect a field motion vector based on the minimum estimation error.

10. The motion vector detecting device of claim 9, wherein:
the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame;
the arithmetic operation means alternately performs
a first arithmetic operation of calculating estimation errors between the odd-numbered columns of the field which is a constituent of the reference image frame and odd-numbered columns of the current image block and
a second arithmetic operation of calculating estimation errors between the even-numbered columns of the field which is a constituent of the reference image frame and odd-numbered columns of the current image block; and
the field comparator detects the field motion vector based on a result of the first arithmetic operation of the arithmetic operation means and a result of the second arithmetic operation of the arithmetic operation means.

11. The motion vector detecting device of claim 9, wherein:
the n reference image storages include a reference image even-numbered column pixel storage for storing and outputting pixel data of even-numbered columns of the field which is a constituent of the reference image frame and a reference image odd-numbered column pixel storage for storing and outputting pixel data of odd-numbered columns of the field which is a constituent of the reference image frame;
the arithmetic operation means alternately performs
a first arithmetic operation of calculating estimation errors between the odd-numbered columns of the field which is a constituent of the reference image frame and odd-numbered columns of the current image block and
a second arithmetic operation of calculating estimation errors between the even-numbered columns of the field which is a constituent of the reference image frame and even-numbered columns of the current image block; and
the field comparator detects the field motion vector based on a result of the first arithmetic operation of the arithmetic operation means and a result of the second arithmetic operation of the arithmetic operation means.

12. A motion vector detecting method for detecting as a motion vector a candidate vector which minimizes an estimation error for a current image block in a current image frame with respect to a reference image frame, comprising the steps of:
sequentially calculating estimation errors for respective candidate vectors of the current image block, for combinations of an odd-numbered or even-numbered field which is a constituent of the reference image frame and an odd-numbered or even-numbered field of the current image block, based on pixel data of the odd-numbered or even-numbered field of the reference image frame and pixel data of the odd-numbered or even-numbered field of the current image frame;
calculating the minimum estimation error among the sequentially calculated estimation errors to calculate a field motion vector; and
storing a plurality of estimation errors calculated for one of the combinations on a field-by-field basis and calculating a frame motion vector based on an estimation error calculated for a combination corresponding to the one combination and a corresponding one of the plurality of stored estimation errors.

13. The motion vector detecting method of claim 12, wherein the step of calculating the frame motion vector includes the step of storing the plurality of estimation errors which are calculated for one of the combinations by overwriting a region where the pixel data of the reference image frame or the pixel data of the current image block is stored.

14. A motion vector detecting method for detecting as a motion vector a candidate vector which minimizes an estimation error for a current image block in a current image frame with respect to a reference image frame, comprising the steps of:
sequentially calculating estimation errors for respective candidate vectors of the current image block, for combinations of an odd-numbered or even-numbered field which is a constituent of the reference image frame and an odd-numbered or even-numbered field of the current image block, based on pixel data of the odd-numbered or even-numbered field of the reference image frame and pixel data of the odd-numbered or even-numbered field of the current image frame;
calculating the minimum estimation error among the sequentially calculated estimation errors to calculate a field motion vector; and
storing an estimation error for one candidate vector which is calculated for one of the combinations and calculating a frame motion vector based on an estimation error calculated for a combination corresponding to the one combination and the stored estimation error for the one candidate vector.

15. A motion vector detecting method for detecting as a motion vector a candidate vector which minimizes an estimation error for a current image block in a current image frame with respect to a reference image frame, comprising the steps of:
sequentially calculating estimation errors for respective candidate vectors of image segments of the current image block, for combinations of pixel data of image segments of the reference image frame and pixel data of the image segments of the current image block, based on the pixel data of the image segments of the reference image frame and the pixel data of the image segments of the current image block, the image segments of the reference image frame being obtained by thinning a field which is a constituent of the reference image frame at a cycle of n columns or n rows, and the image segments of the current image block being obtained by thinning the current image block at a cycle of n columns or n rows (where n is a natural number equal to or greater than 2); and
storing an estimation error for one candidate vector which is calculated for one of the combinations and calculating a field motion vector based on an estimation error calculated for a combination corresponding to the one combination and the stored estimation error for the one candidate vector.

16. A motion vector detecting method for detecting as a motion vector a candidate vector which minimizes an estimation error for a current image block in a current image frame with respect to a reference image frame, comprising the steps of:
sequentially calculating estimation errors for respective candidate vectors of image segments of the current image block based on the pixel data of image segments of the reference image frame and the pixel data of any one of the image segments of the current image block, the image segments of the reference image frame being obtained by thinning a field which is a constituent of the reference image frame at a cycle of n columns or n rows, and the image segments of the current image block being obtained by thinning the current image block at a cycle of n columns or n rows (where n is a natural number equal to or greater than 2); and
calculating a field motion vector based on the sequentially calculated estimation errors.
